(19) United States
(12) Patent Application Publication
(10) Pub. No.: US 2014/0204496 A1
(43) Pub. Date: Jul. 24, 2014

(54) RACK-MOUNTABLE, TILTABLE SURGE PROTECTOR HOUSINGS FOR POWER SURGE PROTECTOR ACCESSIBILITY, AND RELATED ASSEMBLIES, METHODS, AND BASE STATION EQUIPMENT

(71) Applicant: Corning Cable Systems LLC, Hickory, NC (US)

(72) Inventors: Jose Martinez Sanchez, Reynosa (MX); Arturo Sanchez Garcia, Reynosa (MX); Fabiola Patricia Villanueva Tavares, Reynosa (MX)

(73) Assignee: Corning Cable Systems LLC, Hickory, NC (US)

(21) Appl. No.: 14/157,795

(22) Filed: Jan. 17, 2014

Related U.S. Application Data
(60) Provisional application No. 61/790,954, filed on Mar. 15, 2013.
(60) Provisional application No. 61/755,219, filed on Jan. 22, 2013.

(51) Int. Cl. H02H 1/00; H02H 9/00

(52) U.S. Cl. CPC H02H 1/00; H02H 9/005
USPC 361/119; 361/118

(57) ABSTRACT

Rack-mountable, tiltable surge protector housings for power surge protector accessibility are disclosed. Related assemblies, methods, and base station equipment are also disclosed. The surge protector housings may be installed in an equipment rack to support the surge protector housing for use. The surge protector housings support one or more surge protectors for receiving input power through the surge protector housing. The surge protector housing is configured to provide surge protected output power from the received input power. The surge protector housings include a front section having surge protectors supported therein. The front section can be tilted to provide convenient access to the surge protectors, such as during installation and replacement of surge protectors, and connecting power to and disconnecting power from the surge protectors.

### RELATED APPLICATIONS

This application claims the benefit of priority under 35 U.S.C. §119 of U.S. Provisional Application No. 61/790,954 filed on Mar. 15, 2013 and U.S. Provisional Patent Application Ser. No. 61/755,219 filed on Jan. 22, 2013, the contents of which are relied upon and incorporated herein by reference it their entirety.

### BACKGROUND

1. Field of the Disclosure

The technology of the disclosure relates to rack-mounted power surge protector devices that provide surge protection for electrical equipment. The rack-mounted surge protector devices may be employed to protect rack-mounted base station equipment and remote radio heads (RRHs) from power surges.

2. Technical Background

It is common to provide surge protection for electrical equipment. Surge protection is provided by surge protectors, also known as surge suppressors. Surge protectors are devices designed to protect electrical devices from power surges. Power surges are short duration electrical transients in voltage or current in an electrical circuit. Power surges can be caused by various things, such as lightening strikes, power outages, tripped circuit breakers, short circuits, and malfunctions. A surge protector attempts to limit power surges supplied to an electrical device by either blocking or shorting to ground any unwanted voltage or current above a safe threshold for the electrical equipment. For example, for normal household and office wiring in the United States, the standard voltage is 120 Volts (V). A surge protector would protect an electrical device from voltage surges above 120 V.

It is particularly important to provide surge protection for electrical communications equipment to prevent the electrical communications equipment from being damaged and made inoperable as a result of power surges. For example, a cellular base station is one type of electrical communications equipment that may be surge protected. A cellular base station is a wireless communications station installed at a fixed location. Remote radio head (RRH) electrical equipment is provided as part of the base station to provide the base station's radio-frequency (RF) circuitry, analog-to-digital (A/D) and digital-to-analog (D/A) converters, and frequency converters. The RRH distributes RF communications signals to and from radio antennas on a telecommunications tower. Providing surge protection for cellular base stations and RRHs is particularly important, because the cellular base stations are communicatively coupled with radio antennas installed on communications tower, which are tall outdoor structures placed in isolated locations that may be more heavily subjected to atmospheric discharges.

In some cellular base stations installations, the RRHs are installed on the communications tower along with radio antennas. Fiber to the Antenna (“FTTA”) solutions may be employed to distribute optical communications signals to the RRHs on communications towers. The RRHs convert the optical communications signals to electrical communications signals for transmission as wireless communications signals over the radio antennas, and vice versa for wireless communications signals received over the radio antennas. Surge protection can be built into the RRHs. However, some wireless service providers (WSPs) desire additional surge protection beyond what is built into the RRHs by the RRH manufacturer. Also, providing surge protection in the RRHs or mounting the surge protectors on the RRHs increases the size of the RRHs. Increasing the size of the RRHs can increase the WSPs expense. Often, space on a communications tower is leased by WSPs based on space consumed by installed equipment on the communications tower. The larger the RRH and support equipment installed on the communications tower, the more space on the communications tower required and the greater the lease expense. If the WSP provides a typical installation of multiple radios, multiple corresponding RRHs would be installed on a communications tower. Thus, an increase in RRH size from inclusion of surge protectors can have a multiplying effect on the space consumed by the WSP on a communications tower.

### SUMMARY OF THE DETAILED DESCRIPTION

Embodiments disclosed herein include rack-mountable, surge protector housings for power surge protector accessibility. Related assemblies, methods, and base station equipment are also disclosed. The surge protector housing may be installed in an equipment rack as a convenient method to support the surge protector housing for use. The surge protector housing supports one or more surge protectors for receiving input power through the surge protector housing. The surge protector housing is configured to provide surge protected output power from the input power received through the surge protector housing. In embodiments disclosed herein, the surge protector housing allows the surge protectors supported therein to be conveniently accessed through exemplary access features, such as during installation and replacement of surge protectors, and connecting power to and disconnecting power from the surge protectors.

In other embodiments disclosed herein, the surge protector housings also include access features that allow surge protectors installed therein to be accessed for connection and/or disconnection from power without requiring the surge protector housing to be removed from an equipment rack. Similarly, the surge protector housings allow surge protectors installed therein to be replaced as failures occur, without requiring the surge protector housing to be removed from an equipment rack. In this manner, equipment powered by other surge protectors disposed in the surge protector housing that do not require connection, disconnection, or replacement, do not experience power supply interruptions. This may be particularly important for communications equipment, such as cellular base station equipment for example, where disconnecting power to the communications equipment will interrupt communications services.

In this regard, in certain embodiments disclosed herein, rack-mountable, tiltable surge protector housings for power surge protector accessibility are provided. Related assemblies, methods, and base station equipment are also provided. In this regard, in one embodiment, a surge protector housing comprises a chassis comprising an interior area defined by a front end having a front opening and a rear end. The surge protector housing also comprises a power terminal block disposed in the chassis. The surge protector housing also comprises a front section supported at the front end of the chassis and accessible through the front opening of the chassis. The front section includes at least one surge protector mounted to the front section. The at least one surge protector is electrically coupled to the power terminal block with electrical power wiring routed in the interior area of the chassis. The surge protector housing also comprises at least one tilt mechanism connecting the chassis to the front section. The at least one tilt mechanism is configured to be engaged to tilt the front section about the chassis to tilt the at least one surge protector about the chassis to provide tilt access to the at least one surge protector. In this manner, the surge protectors in the surge protector housing can be more easily accessed for power connection and disconnection, and installation and replacements in the surge protector housing.

In another embodiment, a method of providing access to surge protectors in a surge protector housing mounted in an equipment rack is provided. The method comprises releasing at least one tilt mechanism releasably engaging a chassis of a surge protector housing to a front section supported at a front end of the chassis at a non-tilt position stop. The front section includes at least one surge protector mounted to the front section. The at least one surge protector is electrically coupled to a power terminal block disposed in the chassis with power electrical wiring routed in an interior area of the chassis. The method also comprises tilting down the front section of the surge protector housing about the chassis to provide tilt access to the at least one surge protector mounted in the front section. In one embodiment, releasing the at least one tilt mechanism further comprises releasing the at least one tilt mechanism from a non-tilt position stop disposed in at least one tilt plate coupled to the chassis. In another embodiment, the method also comprises engaging the at least one tilt mechanism while the front section is tilted down, in a tilt position stop.

In another embodiment, a base station is provided. The base station comprises at least one base station equipment. For example, the base station equipment may be comprised of one or more remote radio heads (RRHs). The one or more remote radio heads (RRHs) may be co-located with other base station equipment or located on a communications tower. The base station also comprises an equipment rack. The base station also comprises at least one surge protector housing mounted in the equipment rack. The at least one surge protector housing comprises a chassis, a tiltable front section supported at a front end of the chassis, and a front section including at least one surge protector mounted to the front section. The at least one surge protector is electrically coupled to a power terminal block. The tiltable front section is configured to be tilted to provide access to the at least one surge protector. The base station also comprises an input power line coupled to the power terminal block to couple at least a portion of input power to the at least one surge protector. The at least one surge protector comprises an output electrical wire coupled to the power terminal block to interrupt the at least a portion of input power during power surges to provide surge protected output power from the input power on an output power line coupled to the power terminal block. The output power line is coupled to the at least one base station equipment to provide the surge protected output power to the at least one base station equipment.

The surge protector housings disclosed herein may provide power surge protection for electrically powered equipment installed in the equipment rack. As a non-limiting example, the surge protector housing may provide power surge protection for base station equipment that is commonly subjected to power surges and spikes due to their environment. The surge protector housing may also provide power surge protection for other equipment not installed in the equipment rack supporting the surge protector housing. As a non-limiting example, the surge protector housing may provide power surge protection for remote radio heads (RRHs) that are located away from the equipment rack, such as on a communications tower.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1A is a left side, perspective view of an exemplary surge protector housing in a retracted position and mounted in an equipment rack, wherein the surge protector housing has a tilt-down front section for supporting and providing access to surge protectors providing surge protection for electrical devices, including electrical communications devices;

FIG. 1B is a left side, perspective view of the surge protector housing in FIG. 1A, with the front section extended and tilted down to provide access to the surge protectors mounted in a front section of the surge protector housing;

FIG. 2 is a front view of the surge protector housing in FIGS. 1A and 1B, illustrating a front view of the surge protectors installed in the front section of the surge protector housing;

FIG. 3 is a flowchart illustrating an exemplary process for extending the front section of the surge protector housing in FIGS. 1A and 1B from the chassis and tilting the front section about the chassis, to provide tilt access to the surge protectors installed in the front section of the surge protector housing;

FIG. 4 is a left side, perspective view of the surge protector housing in FIGS. 1A and 1B, with a front door unlatched and lowered about the front section to expose the surge protectors for access in the front section of the surge protector housing;

FIG. 5A is a left side, perspective view of the surge protector housing in FIGS. 1A and 1B mounted in an equipment rack, with the front door unlatched and lowered, and the front section extended from the chassis of the surge protector housing, to provide access to the surge protectors installed in the front section of the surge protector housing;

FIG. 5B is a front view of the surge protector housing in FIG. 5A, with the front door unlatched and lowered, and the front section extended from the chassis of the surge protector housing, to provide access to the surge protectors installed in the front section of the surge protector housing;

FIG. 6A is a left side, perspective view of the surge protector housing of FIGS. 1A and 1B with the front section translated and extended out from the chassis about a guide system between the chassis and the front section, with the front section also tilted down about the chassis to provide access to the surge protectors installed in the front section of the surge protector housing;

FIG. 6B is a left side, perspective view of the front section in FIG. 6A translated and extended out from the chassis about the guide system;

FIG. 7A is a left side, perspective view of the surge protector housing in FIGS. 1A and 1B, with the front section extended from chassis and tilted down about the chassis, to provide access to the surge protectors installed in the front section of the surge protector housing;

FIG. 7B is a left side, perspective view of a front portion of the surge protector housing in FIG. 7A removed from the chassis, with the front section extended from the chassis and tilted down about the chassis, to provide access to the surge protectors installed in the front section of the surge protector housing;

FIG. 7C is a left side, perspective, close-up view of a tilt-down latch in the surge protector housing in FIGS. 7A and 7B configured to be engaged to allow the front section of the surge protector housing to be tilted down about the chassis and raised back to a non-tilted position about the chassis;

FIG. 7D is a side view of surge protector housing in FIG. 7B, illustrating the front door unlatched from the chassis, and the front section of the surge protector housing extended from the chassis and tilted down about the chassis, to provide access to the surge protectors installed in the front section of the surge protector housing;

FIG. 8 is a side view of surge protector housing illustrating an alternative front door design with the front door coupled to and unlatched from the front section, and the front section of the surge protector housing extended from chassis and tilted down about the chassis, to provide access to the surge protectors installed in the front section of the surge protector housing;

FIG. 9 is a top, front perspective view of a surge protector housing, with the front section extended from the chassis and illustrating an exemplary surge protector mounting rail disposed in the front section, the surge protection mounting rail configured to support the mounting and securing of surge protectors to the front housing;

FIG. 10 is a top, front perspective view of exemplary surge protectors mounted on the surge protector mounting rail disposed in the front section of the surge protector housing in FIG. 9;

FIG. 11A is a side view of an exemplary surge protector base configured to receive a modular surge protector, the surge protector base configured to be mounted on the surge protector mounting rail disposed in the front section of the surge protector housing in FIG. 9, to secure the surge protector in the front section of the surge protector housing;

FIGS. 11B-1 and 11B-2 are top, side perspective and top, rear perspective views, respectively, of an exemplary modular surge protector configured to be installed in the surge protector base in FIG. 11A;

FIG. 12 is a top, rear perspective view of the surge protector housing in FIG. 9, illustrating the power terminal block and the alarm terminal block disposed through a rear external wall of the chassis for routing power through the surge protector housing to the surge protectors installed therein, and for routing alarm wiring from the surge protectors to an external monitoring system;

FIG. 13 is a top, front perspective view of a ground plate installed between the surge protectors mounted on the surge protector mounting rail to ground the surge protectors to the chassis of the surge protector housing in FIG. 9;

FIG. 14 is a top, front perspective view of the wired alarm terminal blocks installed on the surge protectors mounted on the surge protector mounting rail disposed in the front section of the surge protector housing in FIG. 9;

FIG. 15A is a top view of interior area of the chassis of the surge protector housing in FIG. 9, illustrating exemplary electrical wiring connected to the surge protectors installed in the front section of the surge protector housing and a power terminal block and alarm terminal disposed through a rear internal wall of the chassis, and routed therebetween;

FIG. 15B is a top view of interior area of the chassis of the surge protector housing in FIG. 9, illustrating alternative exemplary electrical wiring connected to the surge protectors installed in the front section of the surge protector housing and a power terminal block and alarm terminal disposed through a rear internal wall of the chassis, and routed therebetween;

FIG. 16A is a left side, perspective view of an alternative exemplary surge protector housing in a retracted position and mounted in an equipment rack, wherein the surge protector housing has a translatable, pull-out surge protector tray for supporting and providing access to surge protectors providing surge protection for electrical devices, including electrical communications devices;

FIGS. 16B and 16C are front and side views, respectively, of the exemplary surge protector housing in FIG. 16A with the front door closed;

FIG. 17 is a left side, perspective view of the surge protector housing in FIGS. 16A-16C mounted in an equipment rack, with the front door unlatched and lowered, and the translatable surge protector tray pulled out from the chassis of the surge protector housing, to provide access to the surge protectors installed in the front section of the surge protector housing;

FIG. 18 is a flowchart illustrating an exemplary process for retracting and extending the translatable surge protection tray of the surge protector housing in FIGS. 16A-16C into and from the chassis, respectively, for access to the surge protectors installed in the translatable surge protection tray of the surge protector housing;

FIG. 19A is a right side, front perspective view of the surge protector housing in FIGS. 16A-16C, with a front door unlatched and lowered about the translatable surge protector tray to expose the translatable surge protector tray;

FIG. 19B is a front perspective view of the surge protector housing in FIGS. 16A-16C, with a front door unlatched and lowered about the translatable surge protector tray to expose the translatable surge protector tray;

FIG. 19C is a close-up, front perspective view of FIG. 19B illustrating a visual indicator panel of the translatable surge protector tray;

FIGS. 20A and 20B are left side, perspective and side views, respectively, of the translatable surge protector tray pulled out from the chassis of the surge protector housing of FIGS. 16A-16C, to provide access to surge protectors mounted on the surge protector tray;

FIG. 21A is a right side, front perspective view of the surge protector housing in FIGS. 16A-16C, with the front door unlatched and lowered about the translatable surge protector tray and illustrating the stop mechanism configured to limit translation of the surge protector tray out from the surge protector housing;

FIG. 21B is a close-up view of the left side of FIG. 21A, to show the left side stop mechanism configured to limit translation of the surge protector tray out from the surge protector housing;

FIGS. 21C and 21D are close-up perspective and front views, respectively, of the right side of FIG. 21A, to show the right side stop mechanism configured to limit translation of the surge protector tray out from the surge protector housing;

FIG. 22A is a top, perspective view of the translatable surge protector tray of the surge protector housing in FIGS. 16A-16C partially pulled out from the chassis;

FIG. 22B is a top, perspective view of the translatable surge protector tray of the surge protector housing in FIGS. 16A-16C fully pulled out from the chassis;

FIG. 22C is a close-up view of FIG. 22B illustrating modular surge protectors mounted in surge protector base that are mounted to the translatable surge protector tray, with one surge protector removed from a surge protector base;

FIG. 23A is a top view of interior of the chassis of the surge protector housing in FIGS. 16A-16C, illustrating exemplary electrical wiring connected to the surge protectors installed on the surge protector tray and a power terminal block and alarm terminal disposed through a rear internal wall of the chassis, and routed therebetween, when the surge protector tray is retracted into the chassis;

FIG. 23B is a top view of interior of the chassis of the surge protector housing in FIG. 23A, illustrating exemplary electrical wiring connected to the surge protectors installed on the surge protector tray and a power terminal block and alarm terminal disposed through a rear internal wall of the chassis, and routed therebetween, when the surge protector tray is extended from the chassis;

FIG. 24 is a left side, perspective view an alternative 3-U exemplary surge protector housing mounted in an equipment rack, wherein the surge protector housing includes a chassis for supporting and providing access to surge protectors mounted thereon providing surge protection for electrical devices, including electrical communications devices;

FIG. 25 is a front view of the surge protector housing in FIG. 24, with a front door unlatched and lowered about the chassis to expose the surge protectors installed in a front section of the chassis;

FIG. 26 is a left side, perspective view of the surge protector housing in FIG. 24 with a cover removed from the chassis;

FIG. 27A is a left side, perspective view of the surge protector housing in FIG. 24 not mounted in an equipment rack;

FIG. 27B is a left side view of the surge protector housing in FIG. 27A;

FIG. 28 is a top view of interior of the chassis of the surge protector housing in FIG. 24, illustrating exemplary electrical wiring connected to the surge protectors installed on the chassis and a power terminal block and alarm terminal disposed through a rear internal wall of the chassis, and routed therebetween; and

FIG. 29 is a schematic diagram of a cellular tower site including a cellular tower having remote radio heads (RRHs) and radio antennas, and a base station enclosure with a base station transmitter and equipment rack having a surge protector housing installed therein, for providing surge protection to power distributed to the RRHs.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein. Whenever possible, like reference numbers will be used to refer to like components or parts.

Embodiments disclosed herein include rack-mountable, surge protector housings for power surge protector accessibility. Related assemblies, methods, and base station equipment are also disclosed. The surge protector housing may be installed in an equipment rack as a convenient method to support the surge protector housing for use. The surge protector housing supports one or more surge protectors for receiving input power through the surge protector housing. The surge protector housing is configured to provide surge protected output power from the input power received through the surge protector housing. In embodiments disclosed herein, the surge protector housing allows the surge protectors supported therein to be conveniently accessed through exemplary access features, such as during installation and replacement of surge protectors, and connecting power to and disconnecting power from the surge protectors.

In other embodiments disclosed herein, the surge protector housings also include access features that allow surge protectors installed therein to be accessed for connection and/or disconnection from power without requiring the surge protector housing to be removed from an equipment rack. Similarly, the surge protector housings allow surge protectors installed therein to be replaced as failures occur, without requiring the surge protector housing to be removed from an equipment rack. In this manner, equipment powered by other surge protectors disposed in the surge protector housing that do not require connection, disconnection, or replacement, do not experience power supply interruptions. This may be particularly important for communications equipment, such as cellular base station equipment for example, where disconnecting power to the communications equipment will interrupt communications services.

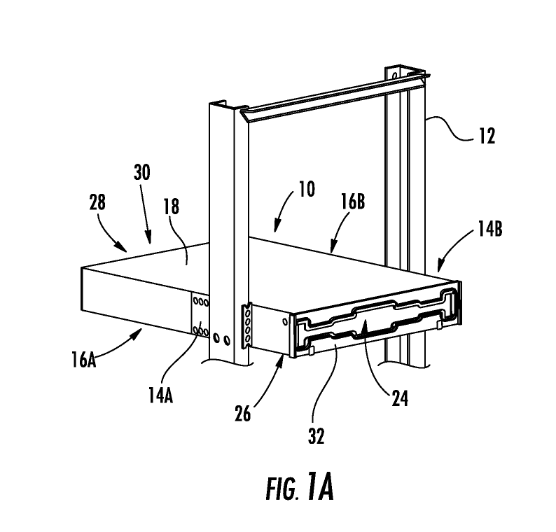

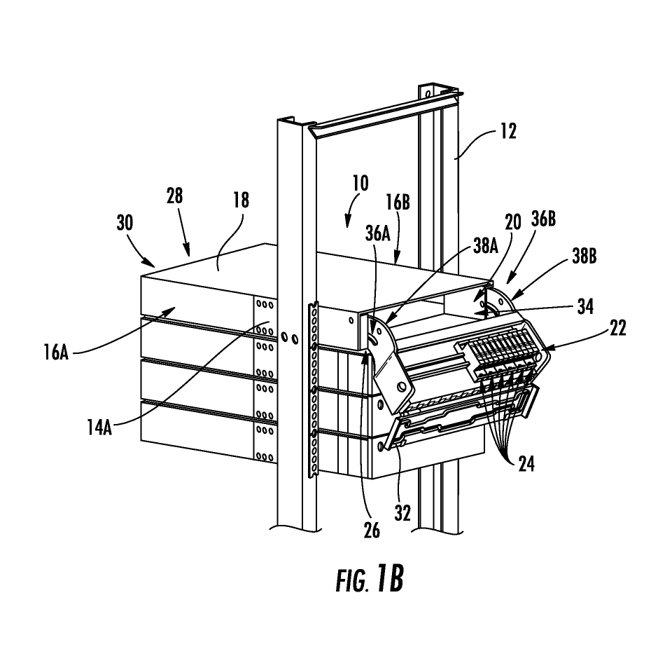

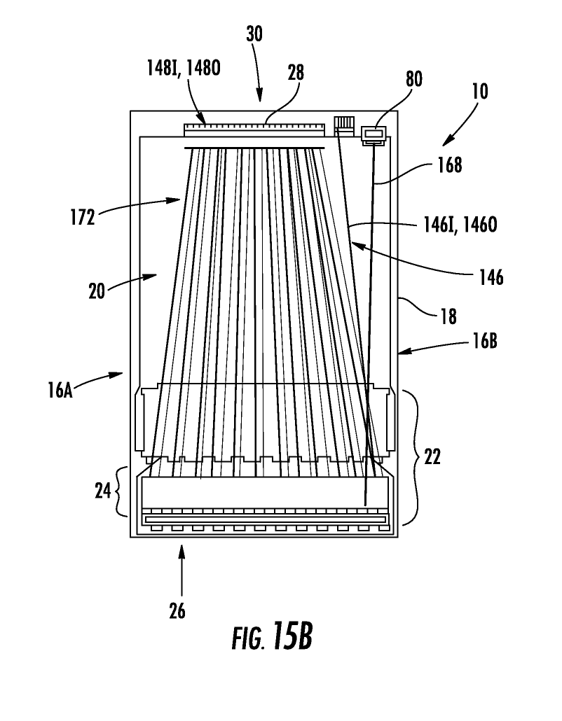

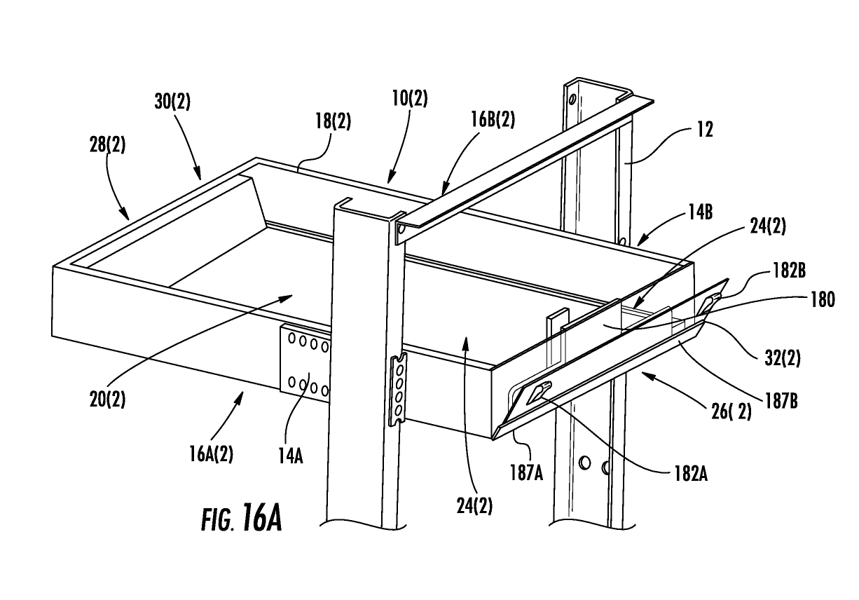

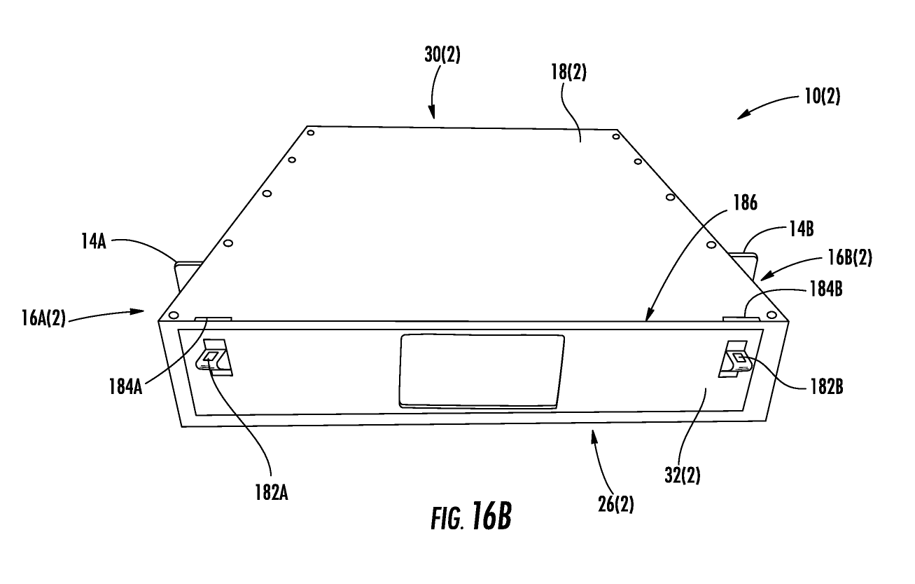

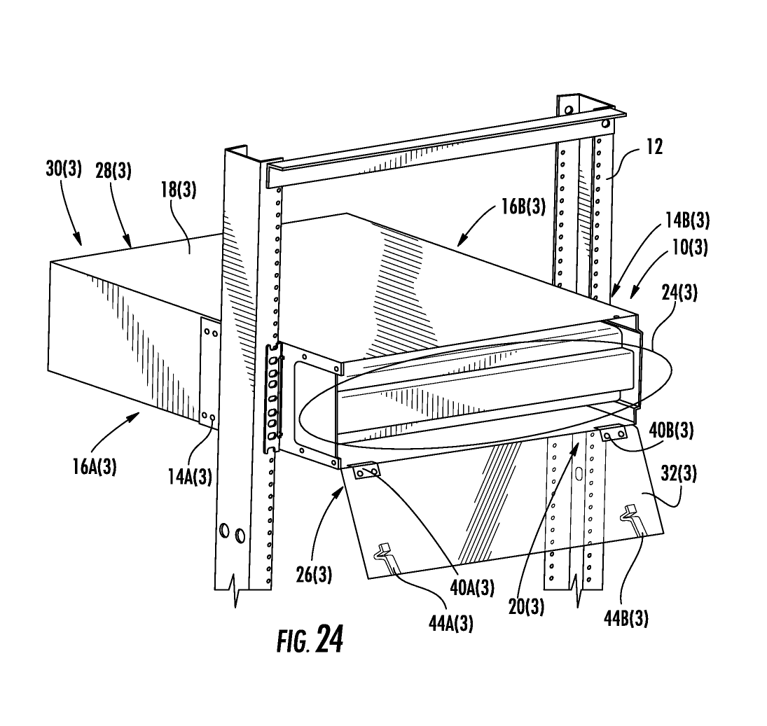

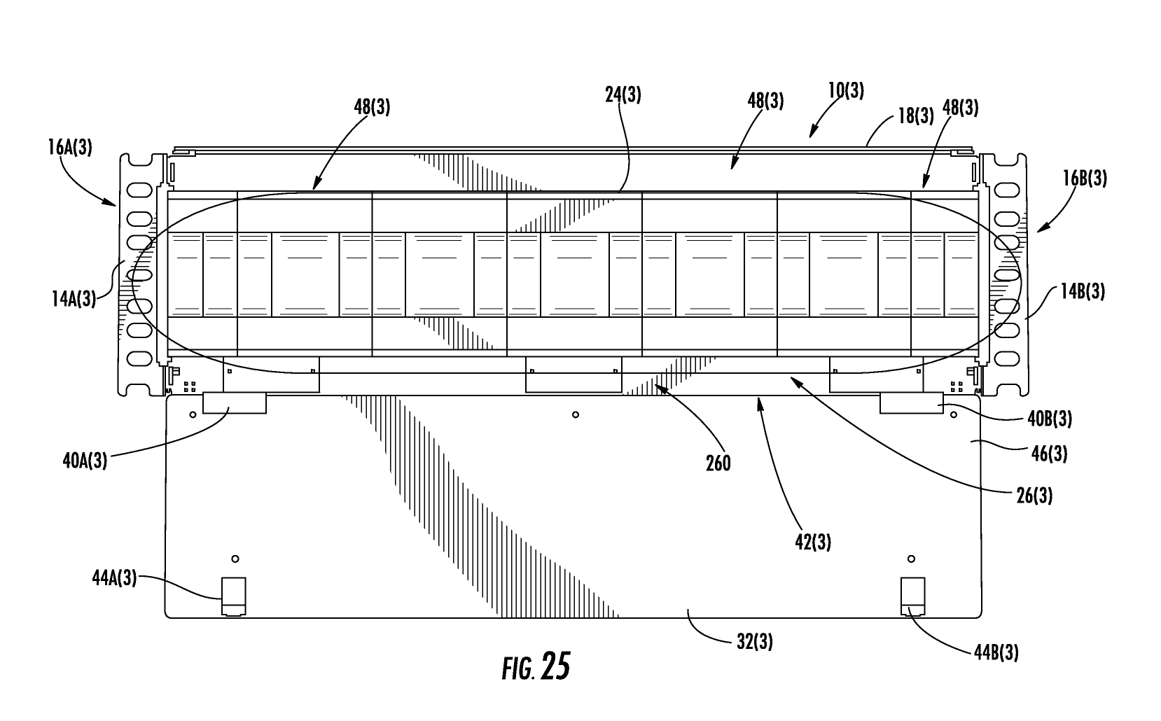

In certain embodiments, examples of which are discussed below with regard to FIGS. 1-15, rack-mountable, tiltable surge protector housings for power surge protector accessibility are provided. In other embodiments, examples of which are discussed below with regard to FIGS. 16-23B, rack-mountable, tiltable surge protector housings for power surge protector accessibility are provided. In other embodiments, examples of which are discussed below with regard to FIGS. 24-28, rack-mountable surge protector housings that include a chassis for supporting and providing access to surge protectors mounted thereon for surge protector accessibility are provided. The embodiments of the rack-mountable, tiltable surge protector housings for power surge protector accessibility will be first described below with regard to FIGS. 1-15.

In this regard, FIGS. 1A and 1B illustrate an embodiment of a rack-mounted, tiltable surge protector housing 10 for power surge protector accessibility. The tiltable surge protector housing 10 is referred to herein as “surge protector housing 10.” As will be discussed in more detail below, the surge protector housing 10 supports one or more surge protectors to provide surge protected power to other power consuming equipment. For example, the surge protector housing 10 may be utilized to provide surge protected power to communications equipment, such as base station equipment supporting cellular communications as one non-limiting example.

The surge protector housing 10 may be based on a “U”-based size with “U” equal to a standard 1.75 inches in height, as a non-limiting example. As non-limiting examples, the surge protector housing 10 may be a 1-U, 2-U, or 3-U size, although the surge protector housing 10 shown in FIGS. 1A and 1B is a 2-U size. The surge protector housing 10 is mounted in an equipment rack 12 in this example as a convenient method to support an installation of the surge protector housing 10. The surge protector housing 10 contains flange brackets 14A, 14B on the left side 16A and right side 16B of the surge protector housing 10 for mounting the surge protector housing 10 to the equipment rack 12. For example, the equipment rack 12 may support equipment, including the surge protector housing 10, that is nineteen inches (19″) or twenty-three inches (23″) in width, as a non-limiting example. The equipment rack 12 may be installed at a facility that includes base stations for supporting cellular communications. Providing surge protection for communications equipment may be particularly important, so that the risk of communications equipment being damaged from power surges and spikes is reduced to avoid or reduce communications service interruptions.

FIG. 1A is a left side, perspective view of the surge protector housing 10 in a refracted position while mounted in the equipment rack 12. The surge protector housing 10 comprises a chassis 18 that provides an interior area 20 for supporting a front section 22 disposed therein, as illustrated in FIG. 1B. A plurality of surge protectors 24 are mounted in the front section 22 to be accessible through a front end 26 of the surge protector housing 10. As will be discussed in more detail below, the surge protectors 24 are electrically coupled to a power terminal block 28 disposed in the chassis 18 to route at least a portion of input power to the surge protectors 24. In this embodiment, the power terminal block 28 is disposed in a rear end 30 of the chassis 18. The surge protectors 24 receive the at least a portion of the input power, and are configured to interrupt providing surge protected output power from the input power to the power terminal block 28 to be distributed to other power-consuming electrical equipment. The surge protectors 24 allow the input power to be provided through the power terminal block 28 as surge protected output power if the surge protector 24 does not detect a power surge. In this embodiment, the surge protectors 24 are supported by the surge protector housing 10 as a single housing. As illustrated in FIG. 1A, a front door 32 of the surge protector housing 10 is closed to close off access to the interior area 20 of the chassis 18 and thus close off access to the front section 22 and the surge protectors 24 mounted thereon in the surge protector housing 10.

However, the front door 32 of the surge protector housing 10 can be opened and lowered as illustrated in FIG. 1B, to allow access to the surge protectors 24 supported in the surge protector housing 10 in the front section 22 disposed in the chassis 18. In this regard, FIG. 1B is a left side, perspective view of the surge protector housing 10 in FIG. 1A, with the front section 22 extended out from the interior area 20 through a front opening 34 in front end 26 of the chassis 18 and tilted downward. Allowing the front section 22 to translate and be extended out from the chassis 18 and tilted downward provides enhanced access to the surge protectors 24 mounted in the front section 22. For example, the surge protector housing 10 may be mounted in a high location in the equipment rack 12 that is more difficult for a technician to reach to access the surge protectors 24. It may be desired to provide access to the surge protectors 24 in the surge protector housing 10 without requiring the surge protector housing 10 to be removed from the equipment rack 12.

In this regard with continuing reference to FIG. 1B, as will be discussed in more detail below, the surge protector housing 10 includes tilt mechanisms 36A, 36B. The tilt mechanisms 36A, 36B include tilt latches 38A, 38B that each connects the chassis 18 of the surge protector housing 10 to the front section 22 of the surge protector housing 10 to maintain the front section 22 in a given orientation to the chassis 18. The tilt latches 38A, 38B are each configured to be engaged to allow the front section 22 to be disengaged from and tilt downward about the chassis 18 to tilt down the surge protectors 24 mounted in the front section 22 about the chassis 18. The front section 22 supporting the surge protectors 24 can tilt downward about the chassis 18 without the chassis having to be moved in or removed from the equipment rack 12. In this manner, the surge protectors 24 in the surge protector housing 10 can be more easily accessed for power connection and disconnection, and installation and replacements in the surge protector housing 10. Providing the ability for the front section 22 to tilt allows for a technician to conveniently access the surge protectors 24 housed in the surge protector housing 10, such as during installation and replacement, and for connecting and disconnecting power.

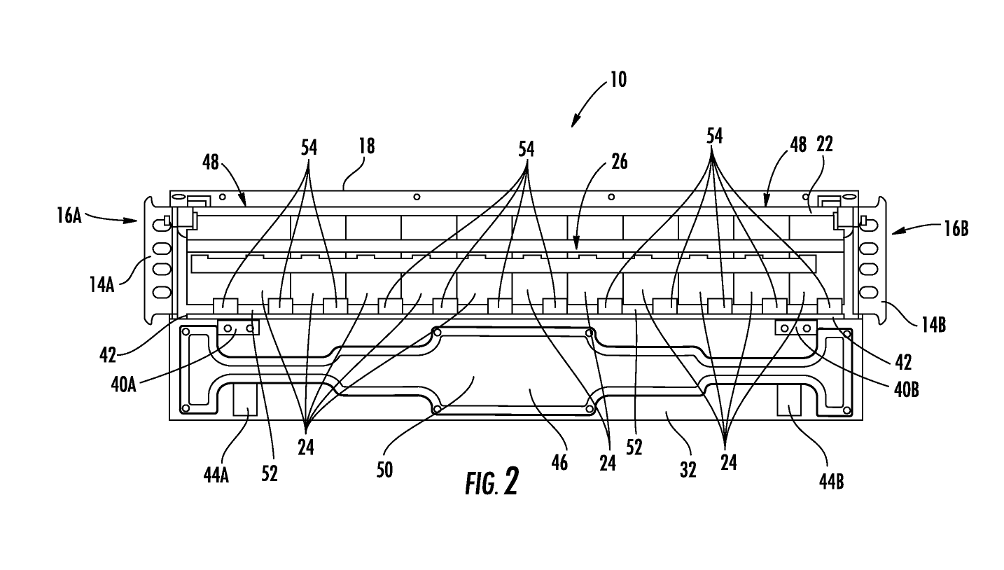

FIG. 2 is a front view of the surge protector housing 10 in FIGS. 1A and 1B, illustrating front views of the surge protectors 24 installed in the front section 22 of the surge protector housing 10. The front door 32 of the surge protector housing 10 is lowered to provide access to the front section 22 in the front end 26 of the chassis 18. The front door 32 is attached to the chassis 18 with hinges 40A, 40B disposed at the bottom section 42 of the left side 16A and right side 16B of the front end 26 of the chassis 18 in this embodiment. To secure the front door 32 in a closed position on the surge protector housing 10 as illustrated in FIG. 1A, latches 44A, 44B disposed in the rear panel 46 of the front door 32 can be engaged and latched into a top section 48 of the chassis 18. The front door 32 in this embodiment includes a transparent window 50 made of translucent material (e.g., plastic, glass, etc.) that allows a technician to view the surge protectors 24 installed in the front section 22 when the front door 32 is closed.

With continuing reference to FIG. 2, the front section 22 is configured to support a plurality of surge protectors 24. As will be discussed in more detail below, the front section 22 includes a mounting structure that allows a plurality of the surge protectors 24 to be installed side-by-side in the front section 22. By the surge protectors 24 being mountable side-by-side in the front section 22, each of the surge protectors 24 is accessible from the front section 26 of the surge protector housing 10. Each of the surge protectors 24 can independently provide surge protected output power to different equipment. Also, as will be discussed in more detail below, the front section 22 is configured to allow each of the surge protectors 24 to be modularly mounted therein. In this manner, each surge protector 24 is independently installable and removable in the front section 22. A technician can install or remove certain surge protectors 24 in the surge protector housing 10 without disturbing other installed surge protectors 24 in the surge protector housing 10.

As further illustrated in FIG. 2, the front section 22 is also configured to allow for a grounding rail 52 to be installed therein. The grounding rail 52 contains a plurality of ground terminals 54 that are spaced apart in the grounding rail 52 to be aligned with grounding terminals (not shown) of the surge protectors 24 as installed in the front section 22. The grounding terminals 54 couple each of the surge protectors 24 to the grounding rail 52. The grounding rail 52 is coupled to the chassis 18 of the surge protector housing 10. The chassis 18 acts as a common ground terminal in this example.

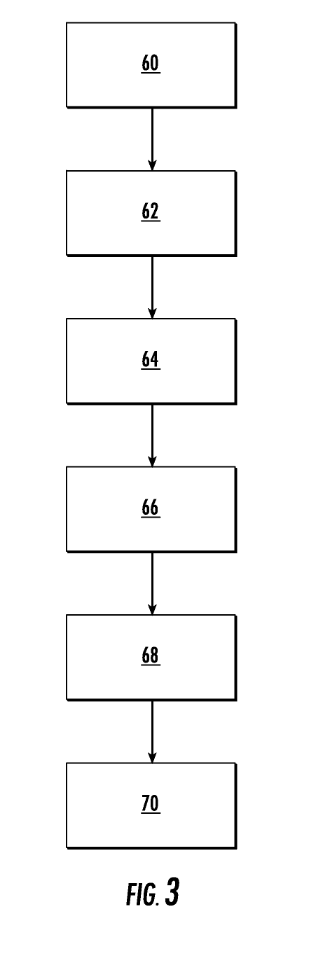

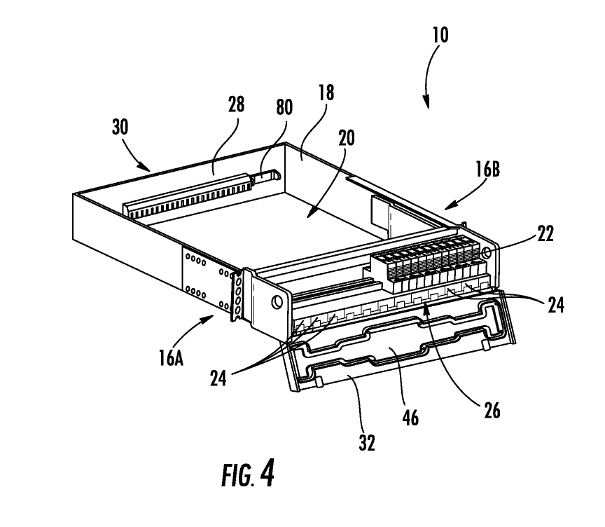

FIG. 3 is a flowchart illustrating an exemplary process for a technician to extend the front section 22 of the surge protector housing 10 in FIGS. 1A and 1B from the chassis 18 and tilting the front section 22 about the chassis 18, to provide tilt access to the surge protectors 24 installed in the front section 22. This process also includes un-tilting and retracting the front section 22 into the chassis 18 of the surge protector housing 10 after access to the surge protectors 24 is completed. This process for extending the front section 22 of the surge protector housing 10 from the chassis 18, tilting the front section 22 about the chassis 18, and retracting the front section 22 back into the chassis 18, will be discussed below in conjunction with the view of the surge protector housing 10 in FIGS. 4-8.

With reference to FIG. 3, the process starts by a technician opening the front door 32 of the surge protector housing 10 (block 60). The surge protector housing 10 installed in the equipment rack 12 after the front door 32 is opened is illustrated in FIG. 4. The surge protectors 24 are shown installed and accessible in the front section 22 of the surge protector housing 10 after the front door 32 is opened. A front door 32 is not required to be opened to access the surge protectors 24 in the front section 22 of the surge protector housing 10 if a front door 32 is not provided on the surge protector housing 10. A front door 32 is also not required to be opened to access the surge protectors 24 in the front section 22 if the front door 32 is already opened.

The surge protector housing 10 in FIG. 4 is illustrated with the top of the chassis 18 removed and the interior area 20 of the chassis 18 exposed. As will be discussed in more detail below, the interior area 20 of the chassis 18 is where electrical wiring (not shown) will be routed for electrical connection to the surge protectors 24 to provide at least a portion of input power to the surge protectors 24. As discussed above, the surge protectors 24 receive at least a portion of the input power and are configured to interrupt providing surge protected output power from the input power during power surges. The surge protectors 24 receive at least a portion of the input power over electrical wiring coupled to the power terminal block 28 disposed in the rear end 30 of the chassis 18. The power terminal block 28 is configured to receive at least a portion of the input power from an external power source electrically coupled to the power terminal block 28 and route the portion of the input power to the surge protectors 24. The power terminal block 28 will also receive the portion of the input power from the surge protectors 24. The surge protectors 24 allow the input power to be provided through the power terminal block 28 as surge protected output power to be distributed externally from the surge protector housing 10 to other power-consuming equipment, if the surge protector 24 does not detect a power surge in the input power from the input power. The surge protectors 24 allow the input power to be provided through the power terminal block 28 as surge protected output power if the surge protector 24 does not detect a power surge.

As will also be discussed in more detail below, FIG. 4 illustrates the alarm terminal block 80 disposed in the rear end 30 of the chassis 18 of the surge protector housing 10. The alarm terminal block 80 provides terminals for coupling of alarm wiring (not shown) routed in the interior area 20 from the surge protectors 24. The surge protectors 24 may be configured to generate and transmit alarms over alarm wiring coupled to the alarm terminal block 80. The alarms generated by the surge protectors 24 may indicate if a surge protector 24 has a fault or has failed. The alarms may be used by technicians or other systems to schedule repairs and replacements of the surge protectors 24 in the surge protector housing 10. In this manner, the alarms can be transmitted over external alarm wiring coupled to the alarm terminal block 80 external to the surge protector housing 10.

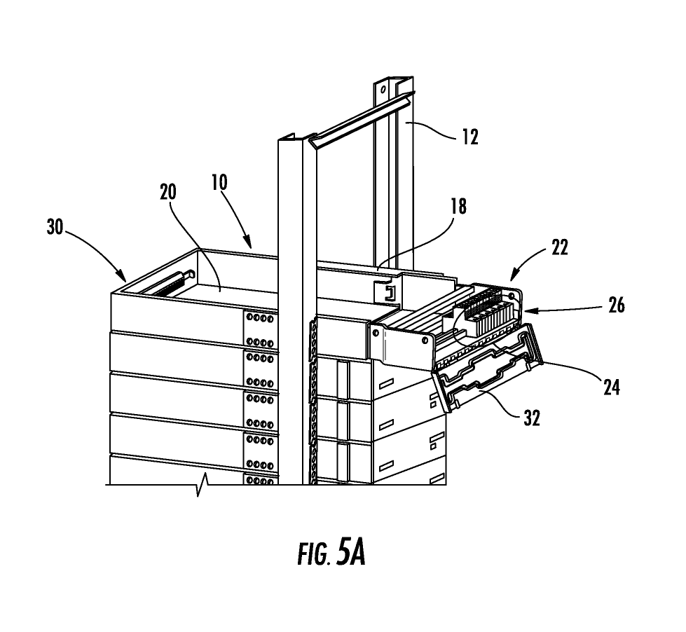

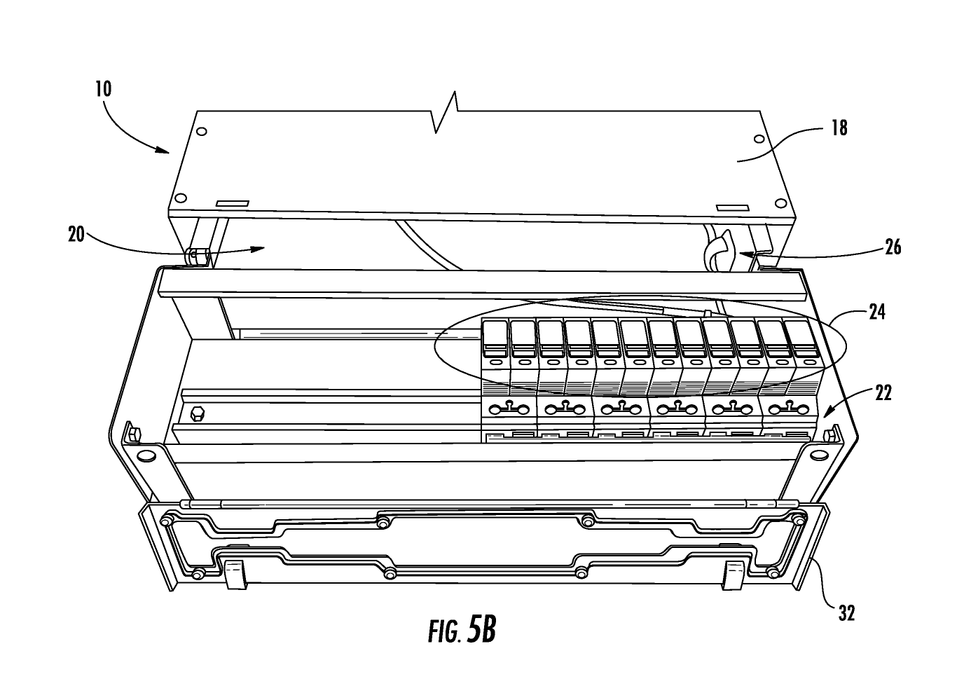

With reference back to FIG. 3, if it is desired to provide tilt access to the front section 22 and the surge protectors 24 installed there after the front door 32 is opened, a technician can next extend the front section 22 out from the front end 26 of the chassis 18 (block 62). The front section 22 extended from the front end 26 of the chassis 18 of the surge protector housing 10 is shown in FIGS. 5A and 5B. FIG. 5A is a left side, perspective view of the surge protector housing 10 mounted in the equipment rack 12, with the front door 32 lowered, and the front section 22 extended from the chassis 18, to provide access to the surge protectors 24 installed in the front section 22 of the surge protector housing 10. FIG. 5B is a front view of the front section 22 of the surge protector housing 10 extended from the chassis 18, to provide access to the surge protectors 24 installed in the front section 22 of the surge protector housing 10.

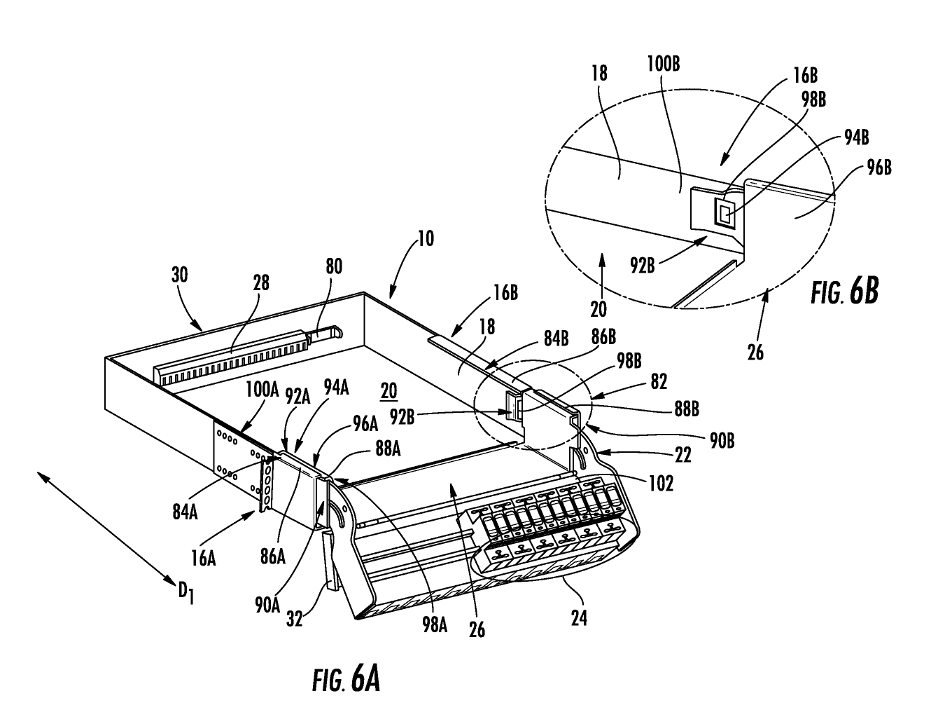

FIGS. 6A and 6B illustrate the guide members provided in the surge protector housing 10 to allow the front section 22 to translate about the chassis 18 to be extended out from the front end 26 of the chassis 18. FIG. 6A is a left side, perspective view of the surge protector housing 10 with the front section 22 extended out from the chassis 18 to provide access to the surge protectors 24 installed in the front section 26 of the surge protector housing 10. FIG. 6A also shows the front section 22 tilted down about the chassis 18. In this embodiment, the front section 22 must be translated and extended out from the front end 26 of the chassis 18 before the front section 22 is clear of the chassis 18 to be able to be tilted downward. FIG. 6B is a left side, perspective view of the guide mechanism for the front section 22 to translate about the chassis 18 of the surge protector housing 10 illustrated in FIG. 6A.

With reference to FIGS. 6A and 6B, the surge protector housing 10 in this embodiment includes a guide system 82. The guide system 82 allows the front section 22 to translate about the chassis 18, along a longitudinal direction D₁ between the front end 26 and the rear end 30 of the chassis 18, to allow the front section 22 to be extended out from the front end 26 of the chassis 18. In this regard, the guide system 82 in this embodiment includes guide members 84A, 84B provided as part of the chassis 18. The guide members 84A, 84B are disposed on the left side 16A and the right side 16B of the chassis 18, respectively, as illustrated in FIGS. 6A and 6B. The guide members 84A, 84B, include a guide surface 86A, 86B configured to allow complementary guide members 88A, 88B provided on the left side 90A and right side 90B of the front section 22, respectively, to abut the guide surfaces 86A, 86B and translate about the guide surfaces 86A, 86B.

With continuing reference to FIGS. 6A and 6B, to limit the translation of the front section 22 out from the chassis 18 and prevent the front section 22 from being removed from the chassis 18, the stop latches 92A, 92B are provided. The stop latches 92A, 92B are comprised of tabs 94A, 94B disposed on left and right interior side walls 96A, 96B of the front section 22 configured to engage with slots 98A, 98B disposed in interior walls 100A, 100B of the chassis 18. The tabs 94A, 94B are biased forward to engage and be limited by the complementary slots 98A, 98B when the front section 22 is translated a designed distance from the front end 26 of the chassis 18. A rear end 102 of the front section 22 is extended from the interior area 20 of the chassis 18 when the front section 22 is fully extended out from the chassis 18. The tabs 94A, 94B can be disengaged from the slots 98A, 98B by translating the front section 22 back into the interior area 20 of the chassis 18, when desired.

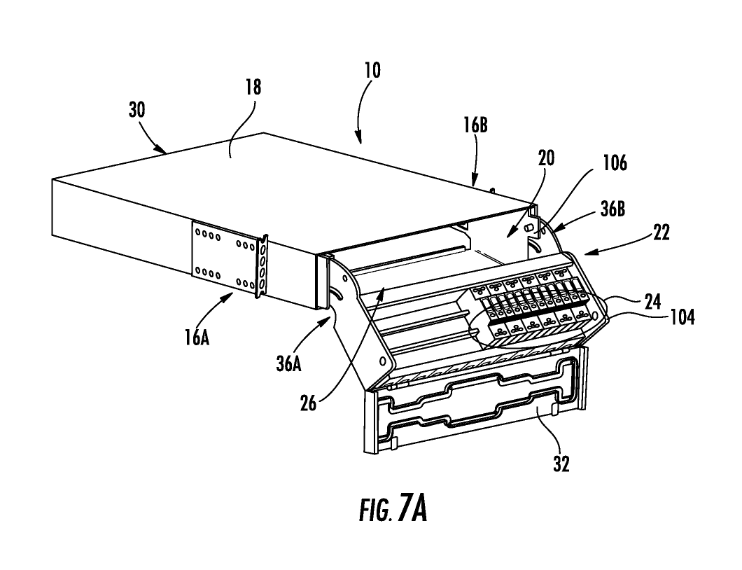

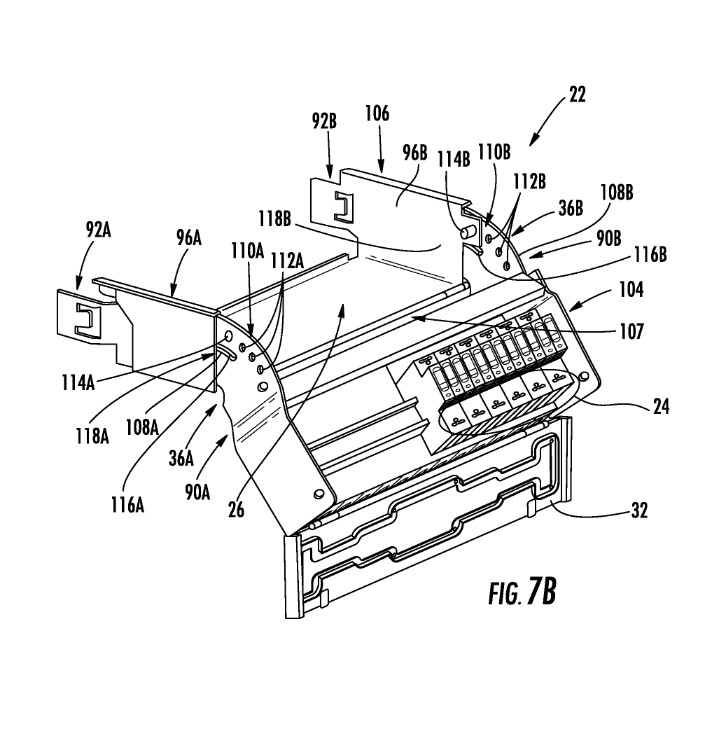

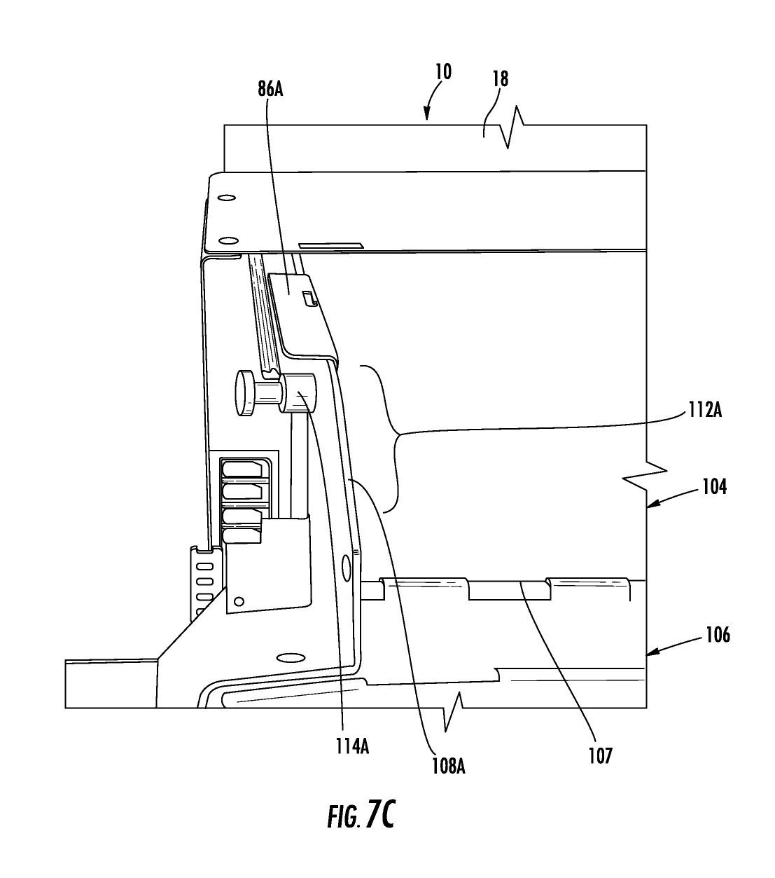

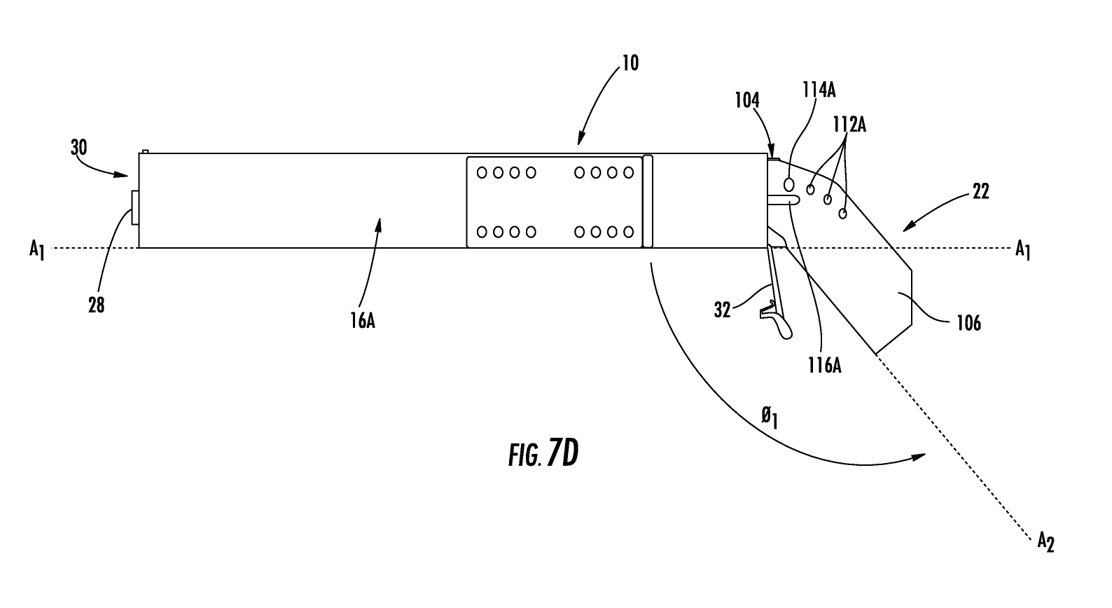

With reference back to FIG. 3, after the front section 22 is extended out from the chassis 18, the front section 22 can be tilted downward about the chassis 18, if desired, to provide tilt access to the surge protectors 24 installed in the front section 22 (block 64). In this embodiment, the front section 22 cannot be tilted about the chassis 18 when the front section 22 is retracted into the interior area 20 of the chassis 18. The front section 22 extended from the front end 26 of the chassis 18 of the surge protector housing 10 and tilted downward is shown in FIGS. 6A and 6B, described above. The front section 22 extended from the front end 26 of the chassis 18 of the surge protector housing 10 and tilted downward is also shown in FIGS. 7A and 7B. FIG. 7A is a left perspective view of the surge protector housing 10 with the front section 22 extended out from the chassis 18 and tilted downward about the chassis 18, to provide access to the surge protectors 24 installed in the front section 22. FIG. 7B is a left side, perspective view of a front section 22 of the surge protector housing 10 in FIG. 7A removed from the chassis 18, to illustrate the tilt mechanisms 36A, 36B in more detail.

With reference to FIG. 7A, the tilt mechanisms 36A, 36B of the surge protector housing 10 are engaged with the front section 22 tilted downward. The front section 22 is comprised of a front tilt housing 104 and a rear housing 106. The front tilt housing 104 is attached via hinge 107 to the rear housing 106, such that the front tilt housing 104 can rotate and tilt about the rear housing 106. As illustrated in FIG. 7B, the tilt mechanisms 36A, 36B in this embodiment are comprised of tilt plates 108A, 108B. The tilt plates 108A, 108B are part of the front tilt housing 104 of the front section 22. The surge protectors 24 are configured to be supported in the front tilt housing 104. The tilt plates 108A, 108B are disposed on the left side 90A and right side 90B of the rear housing 106 of the front section 22, respectively. The tilt plates 108A, 108B each include an arced top surface 110A, 110B that each contains a plurality of orifices 112A, 112B in arced alignment with the top surfaces 110A, 110B, respectively. Each of the orifices 112A, 112B form tilts position stops. Alternatively, note that each of the arced top surfaces 110A, 110B could contain a single orifice to provide one tilt position stop. Spring plungers 114A, 114B disposed in the left and right interior side walls 96A, 96B of the rear housing 106 of the front section 22, are configured to releasably engage with the orifices 112A, 112B as the front tilt housing 104 is rotated about the rear housing 106.

FIG. 7C illustrates a close-up view of the spring plunger 114A on the left side 90A of the front section 22 being engaged to release the front tilt housing 104 from the tilt plate 108A. With reference back to FIG. 7B, closed slots 116A, 116B are also disposed in the tilt plates 108A, 108B that receive limiters 118A, 118B (118A hidden) attached to rear housing 106 and disposed in and not releasable from the closed slots 116A, 116B to limit the rotation (i.e. tilt) of the front tilt housing 104 about the rear housing 106 and the chassis 18. With continuing reference to FIGS. 7B and 7C, the spring plungers 114A, 114B are engaged until the desired front tilt housing 104 is tilted in the desired tilt position. The spring plungers 114A, 114B are then released to engage with an orifice 112A, 112B to lock the front tilt housing 104 in the desired tilt position. FIG. 7D is a side view of surge protector housing 10 illustrating the front tilt housing 104 of the front section 22 extended from chassis 18 and tilted down about the rear housing 106 and chassis 18, to provide tilt access to the surge protectors 24 installed in the front section 22 of the surge protector housing 10. The tilt angle Ø₁ of the front tilt housing 104 about the longitudinal axis A₁ of the chassis 18 is controlled by orifices 112A, 112B engaged by the spring plungers 114A, 114B. The tilt angle Ø₁ of the front tilt housing 104 is the angle between the longitudinal axis A₁ of the chassis 18 and the tilt axis A₂ of the front tilt housing 104, as illustrated in FIG. 7D. The maximum tilt angle Ø₁ may be fifty degrees (50°) as a non-limiting example.

With reference back to FIG. 3, when it is desired to change the tilt position of the front section 22, such as to retract the front section 22 back into the chassis 18, the spring plungers 114A, 114B are engaged. The front section 22 is tilted upward to un-tilt the front section 22 about the chassis 18 (block 66). The spring plungers 114A, 114B are released to allow the spring plungers 114A, 114B to engage and lock with the orifices 112A, 112B in the tilt plates 108A, 108B that provide the un-tilted position stops for the surge protector housing 10, as illustrated in FIGS. 5A and 5B. The front tilt housing 104 and the rear housing 106 are now aligned. The front section 22 can then be translated about the guide members 84A, 84B to dispose the front section 22 back into the interior area 20 of the chassis (block 68 in FIG. 3). This is illustrated in FIG. 4. The front door 32 can then be closed, if desired (block 70 in FIG. 3).

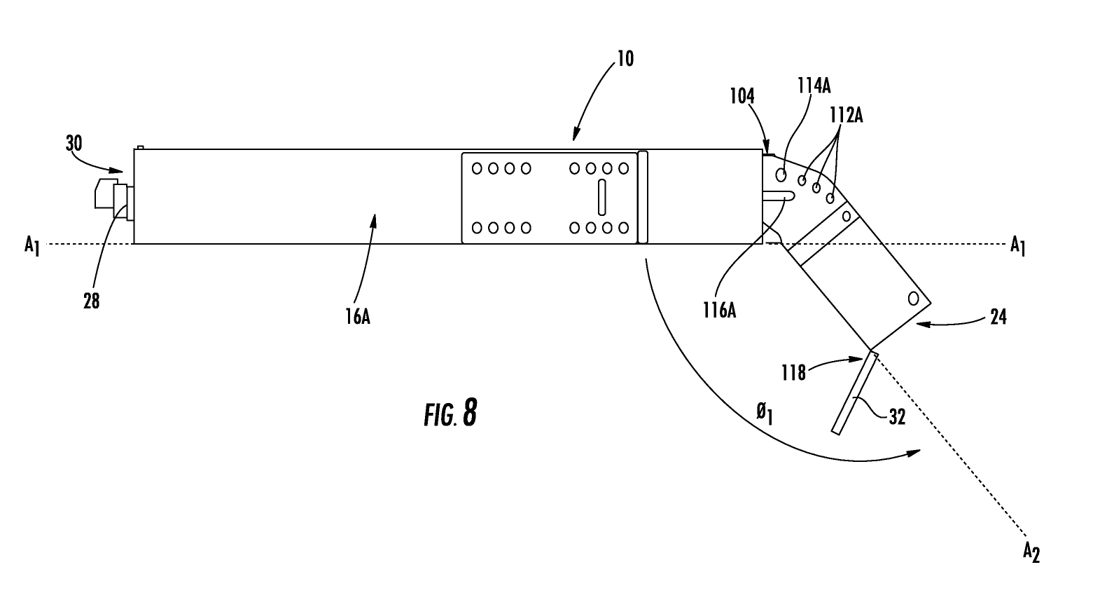

In FIG. 7D, the surge protector housing 10 includes the front door 32 attached to the chassis 18. Thus, the front door 32 has to be unlatched and opened before the front section 22 can be translated out of the interior area 20 of the chassis 18 and tilted. However alternatively, the front door 32 could be attached to the front end 118 of the front tilt housing 104 of the front section 22 if desired, as illustrated in FIG. 8. In this manner, the front section 22 could be translated out of the chassis 18 and tilted before the front door 32 is opened to access the surge protectors 24 installed in the front section 22.

Now that the exemplary translation and tilt features of the surge protector housing 10 have been discussed, the surge protector features of the surge protector housing 10 will now be described with regard to FIGS. 9-15.

FIG. 9 is a top, front perspective view of the surge protector housing 10, with the front section 22 extended from the chassis 18. No surge protectors 24 are installed in the front section 22 to show the mounting features for surge protectors 24 in the front section 22. As shown in FIG. 9, an exemplary surge protector mounting rail 130 is disposed in and mounted to the front tilt housing 104 of the front section 22. The mounting rail 130 allows the surge protectors 24 to be installed in the front section 22 modularly and tool-lessly in this embodiment. The mounting rail 130 contains two orifices 132A, 132B disposed near the ends 134A, 134B, respectively, of the mounting rail 130 that are secured with fasteners 136A, 136B to a base 138 of the front tilt housing 104. The mounting rail 130 contains two raised portions 140A, 140B that are configured to lock into complementary features in the housings of surge protectors 24 to lock the surge protectors 24 onto the mounting rail 130 when installed therein.

In this manner, no tools are required to mount the surge protectors 24 in the surge protector housing 10. This may be advantageous if a technician desires to install or replace surge protectors 24 in the surge protector housing 10 without disconnecting power to the surge protector housing 10. Use of tools with metal parts or other electrical conductors provides a risk of a technician improperly following procedures establishing a conductive path between power components and the technician.

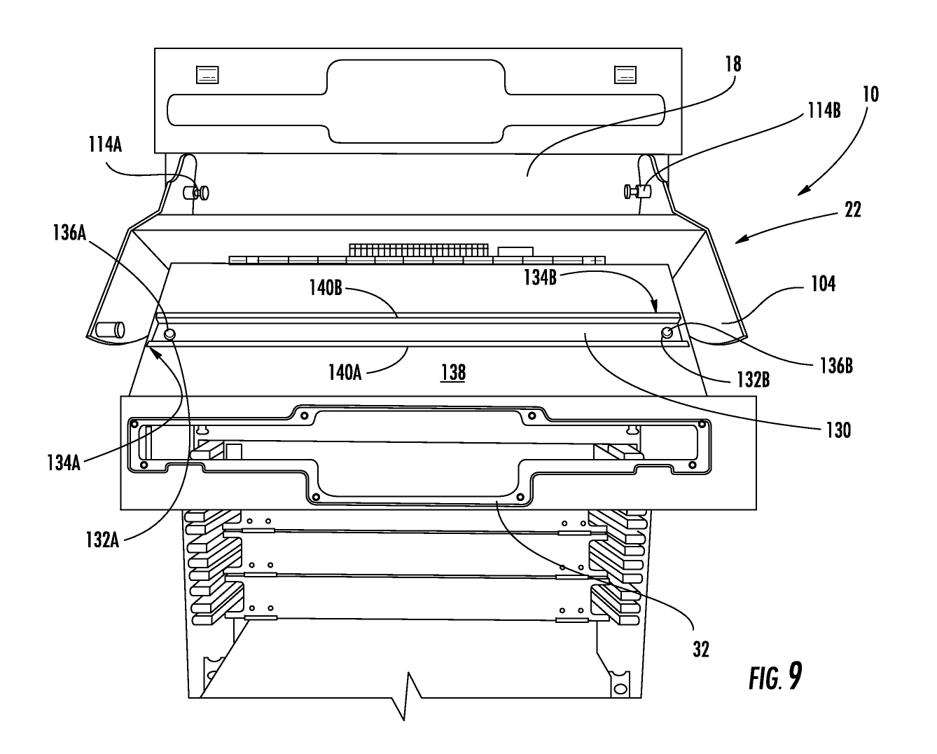

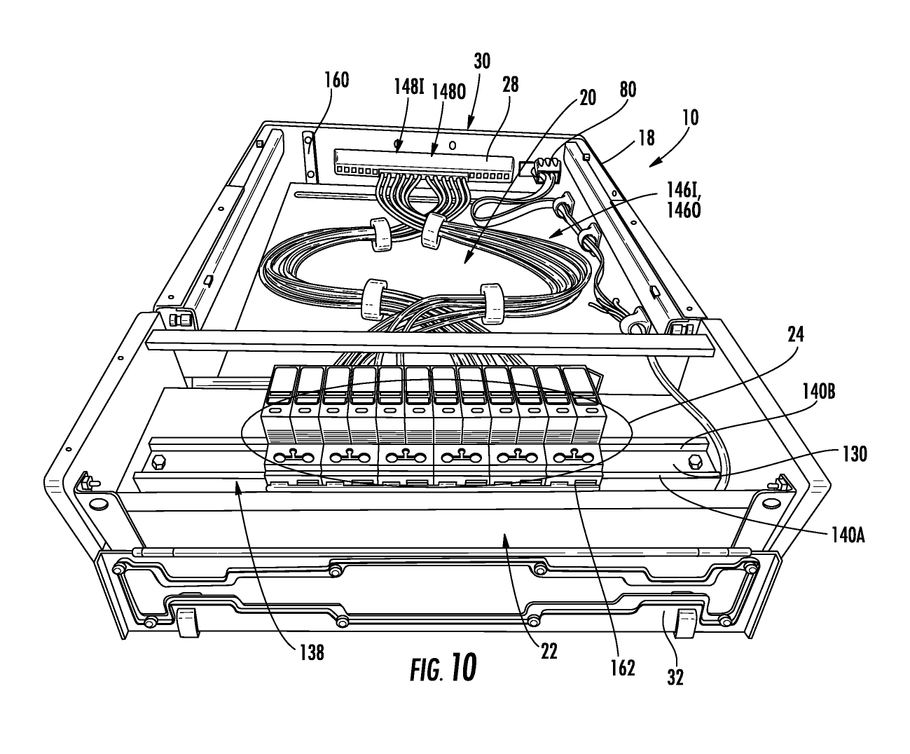

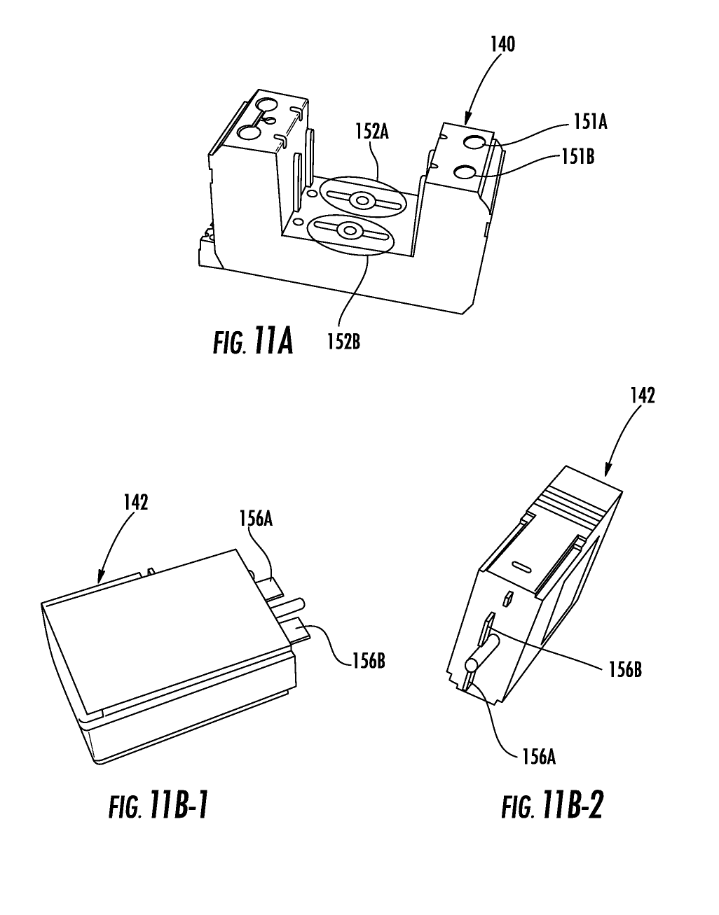

FIG. 10 is a top, front perspective view of exemplary surge protectors 24 mounted on the mounting rail 130 disposed in the front section 22 of the surge protection housing 10. As illustrated in FIG. 10, a plurality of surge protectors 24 is mounted to the mounting rail 130. The surge protectors 24 may be surge protectors manufactured by Phoenix Contact, as a non-limiting example. The exemplary surge protectors 24 are illustrated in FIGS. 11A-11B-2.

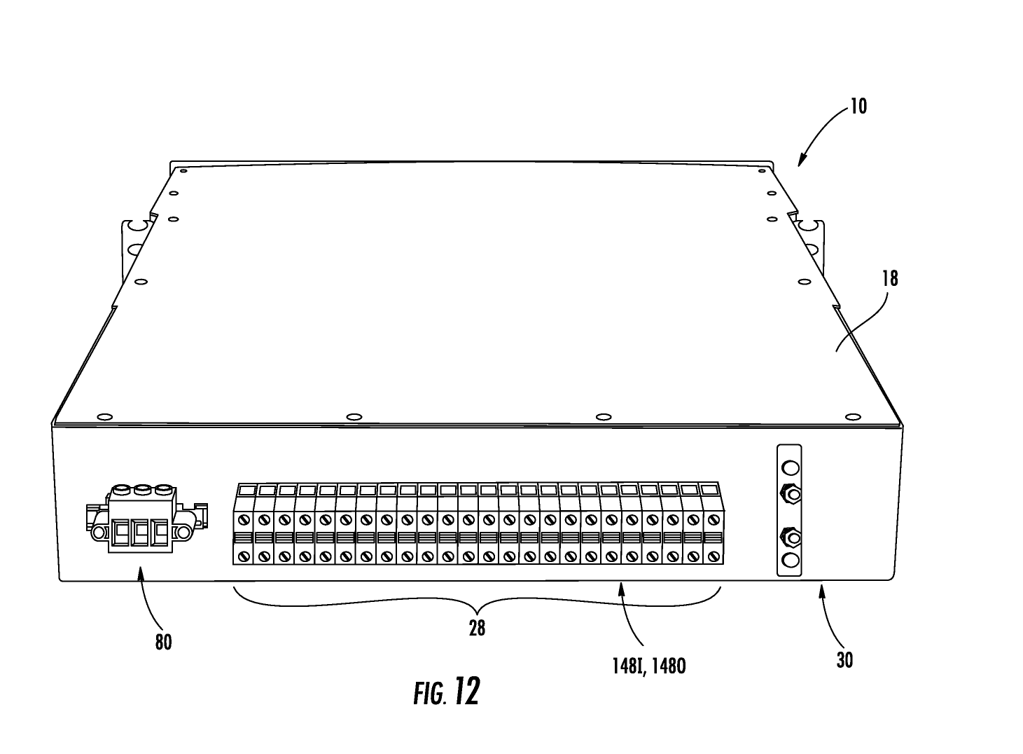

As illustrated in FIGS. 11A-11B-2, the surge protectors 24 are comprised of a surge protector base 140 and a surge protector module 142. The surge protector base 140 is configured to be tool-lessly mounted to the mounting rail 130 in the surge protector housing 10 in FIG. 10. The surge protector base 140 is configured to support two (2) surge protector modules 142 in this embodiment. Thus, two surge protector modules 142 are illustrated in FIGS. 11B-1 and 11B-2. The surge protector base 140 includes terminals 154A, 154B for receiving at least a portion of the input power over input electrical wiring 146I from the power terminal block 28, as illustrated in FIG. 10, and providing surge protected output power over output electrical wiring 146O to the power terminal block 28, as also illustrated in FIG. 10. The input electrical wiring 146I is coupled to at least one input power terminal 148I in the power terminal block 28 configured to receive at least a portion of the input power from at least one external input power line (not shown) connected externally to the chassis 18 to the input power terminal 148I of the power terminal block 28, as illustrated in FIG. 12. The output electrical wiring 146O is coupled to at least one output power terminal 148O in the power terminal block 28 configured to receive interrupted input power during power surges to allow the surge protector 24 installed in a surge protector base 140 to provide the surge protected output power from the input power to at least one external output power line (not shown) connected externally to the output power terminal 148O of the power terminal block 28, as illustrated in FIG. 12.

With continuing reference to FIGS. 10-11B-2, the surge protector base 140 includes two sets of electrical contact slots 152A, 152B that are electrically coupled to terminals 154A, 154B to receive at least a portion of the input power from the power terminal block 28 and are configured to interrupt the input power being provided as surge protected output power to the power terminal block 28 during power surges. The surge protector base 140 is also configured to tool-lessly receive surge protector module 142. Input power from the power terminal block 28 associated with the surge protector base 140 would not be interrupted when the surge protector module 142 is not installed in the surge protector base 140. In this instance, the input power would not be surge protected. The surge protector module 142 contains the electronics to surge protect received a portion of the input power. The surge protector modules 142 have electrical terminals 156A, 156B that are configured to be inserted into either electrical contact slots 152A or 152B to establish an electrical connection. In this manner, power routed from the power terminal block 28 in FIG. 10 to the terminals 144A of the surge protector base 140 is routed to the surge protector modules 142 installed in the surge protector base 140. The surge protected output power provided by the surge protector modules 142 installed in the surge protector base 140 is provided to terminals 144B to be routed back to the power terminal block 28 in the surge protector housing 10.

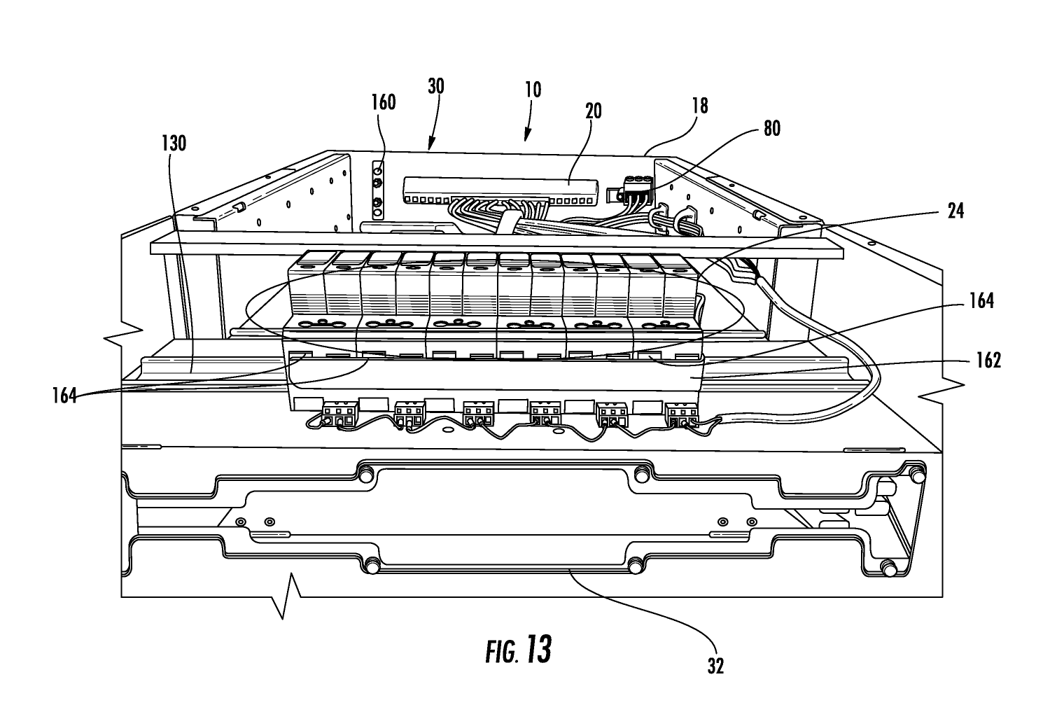

With reference back to FIG. 10, a grounding plate 160 may also be provided on the chassis 18 (e.g., in the rear end 30 of the chassis 18) to be coupled to an external grounding wire to ground the surge protector base 140 and surge protectors 24 installed therein. In this regard, the front section 22 of the surge protector housing 10 is configured to support a grounding bar 162. The grounding bar 162 is coupled to each of the surge protectors 24 as illustrated in FIG. 10 to ground each of the surge protectors 24 to the grounding plate 160 and the chassis 18. A more detailed view of the grounding bar 162 is illustrated in FIG. 13. As illustrated therein, the grounding bar 162 is installed in front of the surge protectors 24. The grounding bar 162 has a plurality of grounding tabs 164 that are each configured to be inserted into and coupled to the surge protectors 24 to providing a common ground for the surge protectors 24 to the chassis 18.

The surge protector housing 10 also supports providing alarms from the surge protectors 24 external to the surge protector housing 10. In this regard, FIG. 14 is a top, front perspective view of the wired alarm terminal blocks 166 installed on the surge protectors 24, which are mounted on the surge protector mounting rail 130. The grounding bar 162 is removed only for clarity in illustration. The surge protectors 24 are configured to generate alarms if the surge protector 24 is damaged or inoperable. In this manner, the alarms can be used by other systems or technicians to know when to replace damaged surge protectors 24 in the surge protector housing 10 to ensure that equipment powered by the surge protector housing 10 receive power. In this regard, a common alarm wiring 168 is routed between the alarm terminal blocks 166 on the surge protectors 24. The alarm wiring 168 is routed in the interior area 20 to the alarm terminal block 80 disposed in the rear end 30 of the chassis 18, as illustrated in FIG. 10.

The input and output electrical wiring 146I, 146O and the alarm wiring 168 can be routed in the interior area 20 of the chassis 18 of the surge protector housing 10 in different manners. The routing should ideally be provided so that the front section 22 can be translated out and tilted about the chassis 18 without disturbing the power and alarm connections between the input and output electrical wiring 146I, 146O and the alarm wiring 168 and the surge protectors 24 in this embodiment. In this manner, power and alarming does not have to be disconnected thus interrupting power from the surge protector housing 10 when accessing the surge protectors 24, including during installation, replacement and repair.

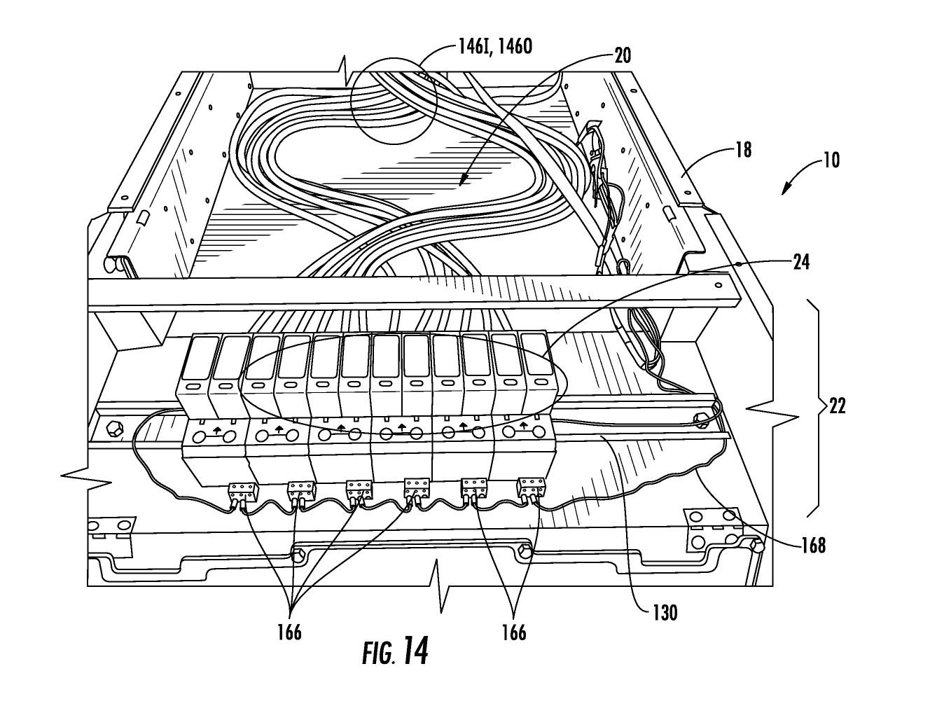

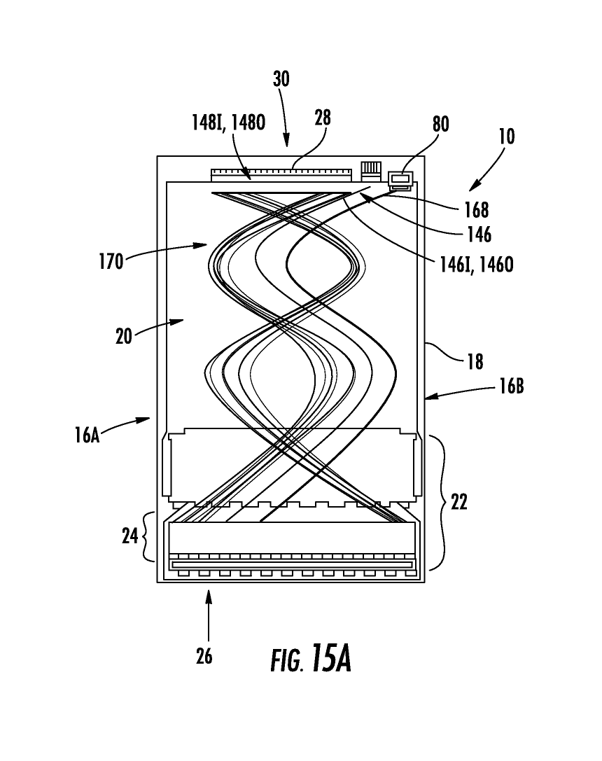

In this regard, FIG. 15A is a top view of interior area 20 of the chassis 18 of the surge protector housing 10 illustrating exemplary routing of the electrical wiring (i.e., input and output electrical wiring 146I, 146O) and alarm wiring 168 connected to the surge protectors 24. In this embodiment, the electrical wiring and alarm wiring 168 is routed in a crossing pattern 170 in the interior area 20. The crossing pattern 170 provides slack in the electrical wiring and alarm wiring 168 that can be extended when the front section 22 is translated out from the chassis 18 without risking disconnecting or damaging the electrical wiring and alarm wiring 168. FIG. 15B is a top view of the interior area 20 of the chassis 20 of the surge protector housing 10 illustrating an alternative exemplary wiring. In this embodiment, the electrical wiring and alarm wiring 168 is routed in a straight wiring pattern 172 in the interior area 20.

Alternative rack-mountable, surge protector housings for power surge protector accessibility can also be provided to the surge protector housing 10 illustrated in FIGS. 1A and 1B and describe above with regard to FIGS. 1A-15B. In this regard, FIGS. 16A-16C illustrate an alternative embodiment of a rack-mounted, surge protector housing 10(2) for power surge protector accessibility. As will be discussed in more detail below, the surge protector housing 10(2) supports one or more surge protectors to provide surge protected power to other power consuming equipment. For example, the surge protector housing 10(2) may be utilized to provide surge protected power to communications equipment, such as base station equipment supporting cellular communications as one non-limiting example. As will also be discussed in more detail below, in the surge protector housing 10(2), the surge protectors are mounted on a surge protector tray that is translatable into and can be translated out/pulled out of a chassis to provide accessibility to the surge protectors. The surge protectors provide surge protection for electrical devices, including electrical communications devices.

In this regard, FIG. 16A is a left side, perspective view of the surge protector housing 10(2) in a retracted position and mounted in the equipment rack 12. FIGS. 16B-16C are front and side views, respectively, of the surge protector housing 10(2) in FIG. 16A with a front door 32(2) closed about a chassis 18(2) of the surge protector housing 10(2). The surge protector housing 10(2) may be based on a “U”-based size with “U” equal to a standard 1.75 inches in height, as a non-limiting example. As non-limiting examples, the surge protector housing 10(2) may be a 1-U, 2-U, or 3-U size, although the surge protector housing 10(2) shown in FIGS. 16A-16C is a 2-U size. The surge protector housing 10(2) is mounted in the equipment rack 12 in this example as a convenient method to support an installation of the surge protector housing 10(2). The surge protector housing 10(2), like the surge protector housing 10 in FIGS. 1A and 1B, contains flange brackets 14A, 14B on the left side 16A(2) and right side 16B(2) of the surge protector housing 10(2) for mounting the surge protector housing 10(2) to the equipment rack 12. For example, the equipment rack 12 may support equipment, including the surge protector housing 10(2), that is nineteen inches (19″) or twenty-three inches (23″) in width, as a non-limiting example. The equipment rack 12 may be installed at a facility that includes base stations for supporting cellular communications. Providing surge protection for communications equipment may be particularly important, so that the risk of communications equipment being damaged from power surges and spikes is reduced to avoid or reduce communications service interruptions.

FIG. 16A is a left side, perspective view of the surge protector housing 10(2) in a retracted position while mounted in the equipment rack 12. The surge protector housing 10(2) comprises the chassis 18(2) that provides an interior area 20(2) for supporting a translatable surge protector tray 180 disposed therein. The translatable surge protector tray 180 is referred to herein as “surge protector tray 180.” A plurality of surge protectors 24(2) are mounted in the surge protector tray 180 to be accessible through a front end 26(2) of the surge protector housing 10(2). In one embodiment, the surge protectors 24(2) are the surge protectors 24 described above and illustrated in FIGS. 10-11B-2. As will be discussed in more detail below, the surge protectors 24(2) are electrically coupled to a power terminal block 28(2) disposed in the chassis 18(2) to route the portion of the input power to the surge protectors 24(2). In this embodiment, the power terminal block 28(2) is disposed in a rear end 30(2) of the chassis 18(2). The surge protectors 24(2) receive the portion of the input power and are configured to interrupt the input power provided as surge protected output power to the power terminal block 28(2) during power surges, to be distributed to other power-consuming electrical equipment. In this embodiment, the surge protectors 24(2) are supported by the surge protector housing 10(2) as a single housing.

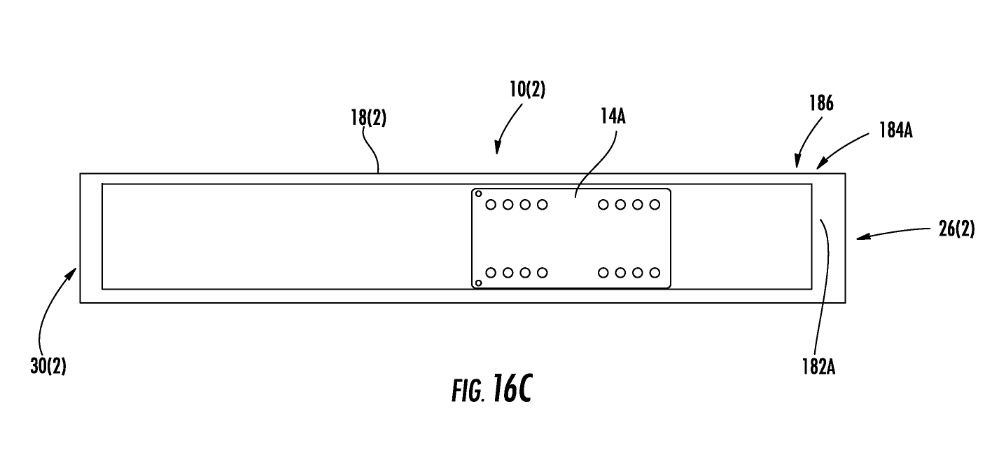

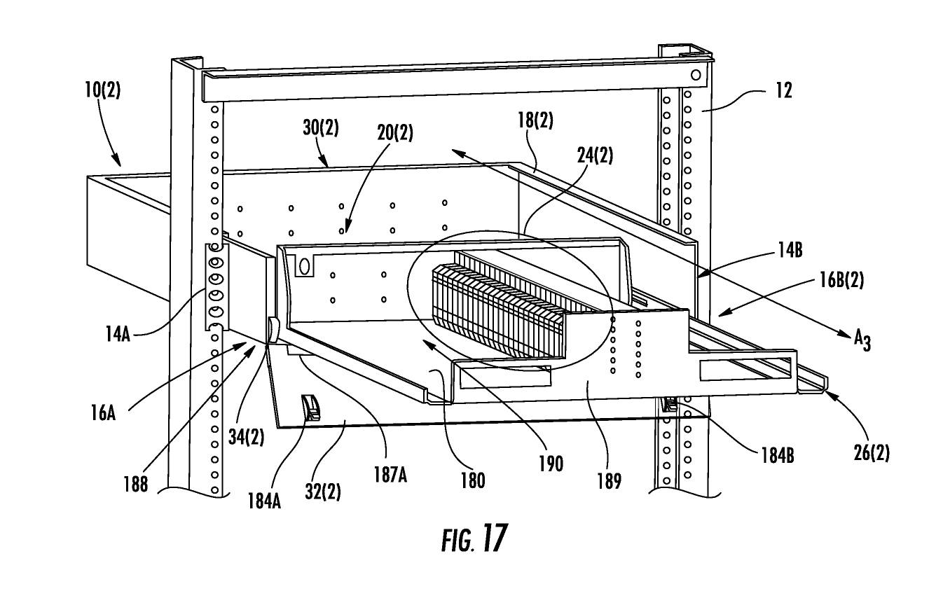

As illustrated in top, perspective and side views of the surge protector housing 10(2) in FIGS. 16B and 16C, respectively, a front door 32(2) of the surge protector housing 10(2) is closed to close off access to the interior area 20(2) of the chassis 18(2). Closing the front door 32(2) of the surge protector housing 10(2) in this embodiment closes off access to the surge protector tray 180 and the surge protectors 24(2) mounted thereon disposed in the interior area 20(2) of the surge protector housing 10(2). However, the front door 32(2) of the surge protector housing 10(2) can be opened and lowered, as illustrated in FIG. 16A, to allow access to the surge protectors 24(2) supported in the surge protector tray 180 disposed in the chassis 18(2) of the surge protector housing 10(2). The front door 32(2) can be opened by engaging door latches 182A, 182B, as illustrated in FIGS. 16A-16C, to release the door latches 182A, 182B from engaging slots 184A, 184B in top portion 186 of the front end 26(2) of the chassis 18(2), as illustrated in FIGS. 16B and 16C. The front door 32(2) is attached to the chassis 18(2) with hinges 187A, 187B disposed at a bottom section 188 of the left side 16A(2) and right side 16B(2) of the front end 26(2) of the chassis 18 in this embodiment, as illustrated in FIG. 17 discussed below.

FIG. 17 is a left side, perspective view of the surge protector housing 10(2) in FIGS. 16A-16C, with the surge protector tray 180 extended out from the interior area 20(2) of the chassis 18(2) through a front opening 34(2) in front end 26(2) of the chassis 18(2). In this embodiment, the surge protector tray 180 does not further tilt like the front section 22 in the surge protector housing 10 in FIGS. 1A and 1B. Allowing the surge protector tray 180 to translate and be extended out from the chassis 18(2) provides enhanced access to the surge protectors 24(2) mounted in the surge protector tray 180. The surge protector tray 180 in this embodiment, allows surge protectors 24(2) mounted in the depth longitudinal axis A₃ extending between the front end 26(2) and the rear end 30(2) of the chassis 18(2) to be accessible. The surge protector tray 180 can be translated and extended out from the interior area 20(2) of the chassis 18(2) to gain easier access to the surge protectors 24(2), especially those not mounted near the front end 189 of the surge protector tray 180.

With continuing reference to FIG. 17, the surge protector tray 180 is configured to support a plurality of surge protectors 24(2). As will be discussed in more detail below, the surge protector tray 180 includes a mounting structure that allows a plurality of the surge protectors 24(2) to be installed side-by-side in a base 190 of the surge protector tray 180. Each of the surge protectors 24(2) can independently provide surge protected output power to different equipment. Also, as will be discussed in more detail below, the surge protector tray 180 is configured to allow each of the surge protectors 24(2) to be modularly mounted therein. In this manner, each surge protector 24(2) is independently installable and removable in the front section surge protector tray 180. A technician can install or remote certain surge protectors 24(2) in the surge protector tray 180 of the surge protector housing 10(2) without disturbing other installed surge protectors 24(2) in the surge protector tray 180.

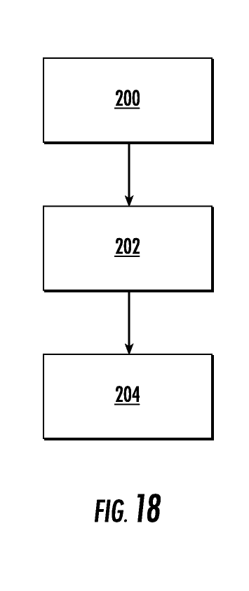

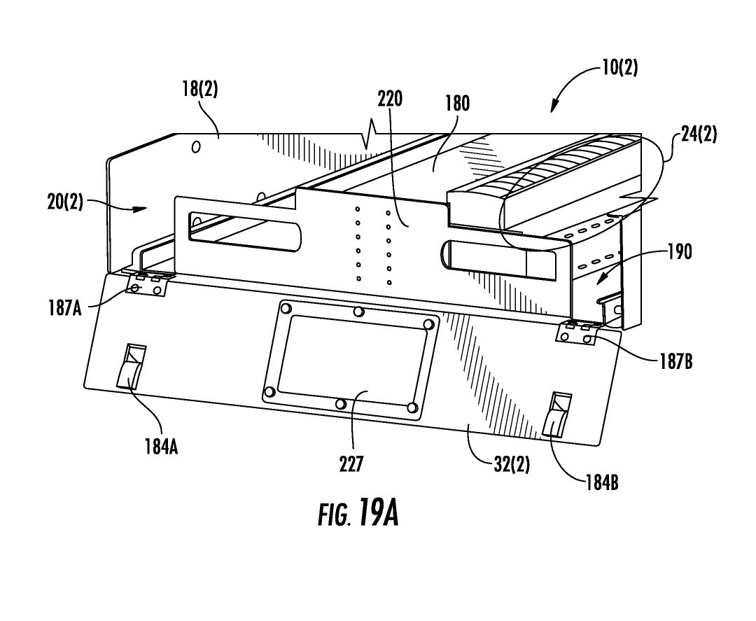

FIG. 18 is a flowchart illustrating an exemplary process for a technician to extend the surge protector tray 180 of the surge protector housing 10(2) in FIGS. 17A-17C from the chassis 18(2), to provide access to the surge protectors 24(2) installed in the surge protector tray 180. This process also includes retracting the surge protector tray 180 into the chassis 18(2) of the surge protector housing 10(2) after access to the surge protectors 24(2) is completed. This process for extending the surge protector tray 180 of the surge protector housing 10(2) from the chassis 18(2), and retracting the surge protector tray 180 back into the chassis 18(2), will be discussed below in conjunction with the view of the surge protector housing 10(2) in FIGS. 19A-23B.

With reference to FIG. 18, the process starts by a technician opening the front door 32(2) of the surge protector housing 10(2) (block 200). The surge protector housing 10(2) after the front door 32(2) is opened is illustrated in FIGS. 19A-19C. The surge protectors 24(2) can be seen as being located behind a front panel 220 of the surge protector tray 180 in FIG. 19A. The front panel 220 of the surge protector tray 180 can also be seen in the front, perspective view of the surge protector housing 10(2) in FIG. 19B and in the close-up view in FIG. 19C. As illustrated in FIG. 19B, the front panel 220 of the surge protector tray 180 is attached to and disposed orthogonal to the base 190 of the surge protector tray 180. The front panel 220 is comprised of a center section 222 that is taller than and in the center of two side sections 224A, 224B disposed on each side of the center section 222. The center section 222 extends almost to the top portion 186 of the front end 26(2) of the chassis 18(2). The side sections 224A, 224B do not extend to the top portion 186 of the front end 26(2) of the chassis 18(2). The side sections 224A, 224B are short enough that a technician can reach his/her hand into the interior area 20(2) of the chassis 18(2) between the top portion 186 of the front end 26(2) of the chassis 18(2) and the side sections 224A, 224B. The technician may then pull on a side section 224A, 224B to translate the surge protector tray 180 out from the chassis 18(2), as will be described in more detail below.

With continuing reference to FIGS. 19B and 19C, the center section 222 of the front panel 220 has a series of openings 225 disposed therein. These openings 225 can be used to support visual indicators (not shown) (e.g., light emitting diodes (LEDs)) disposed therein. The visual indicators may be associated with each of the surge protectors 24(2) installed in the surge protector tray 24(2). The visual indicators may be capable of indicating a status of the surge protectors 24(2) visually. For example, a visual indicator being illuminated may be indicative of a surge protector 24(2) having a normal operational status or a fault operational status. Also, the color of the visual indicator may be indicative of the operational status of the surge protectors 24(2). For example, green color may be normal operational status, and red color may be fault operational status. The front door 32(2) in this embodiment includes a transparent window 227 made out translucent material (e.g., plastic, glass, etc.) to allow a technician to view the visual indicators disposed in the front panel 220.

With reference back to FIG. 19A, the surge protector housing 10(2) is illustrated with the top of the chassis 18(2) removed and the interior area 20(2) of the chassis 18(2) exposed. As will be discussed in more detail below, the interior area 20(2) of the chassis 18(2) is where electrical wiring (not shown) will be routed for electrical connection to the surge protectors 24(2) to provide at least a portion of the input power to the surge protectors 24(2). As discussed above, the surge protectors 24(2) receive the input power and interrupt the input power provided as surge protected output power from the input power during power surges. The surge protectors 24(2) receive the portion of the input power through electrical wiring connected to electrical connectors disposed on a rear end of the surge protector tray 180. These electrical connectors are connected to a power terminal block 28(2) (FIG. 16A) disposed in the rear end 30(2) of the chassis 18(2) when the surge protector tray 180 is retracted into the chassis 18(2). The power terminal block 28(2) is configured to receive the portion of input power from an external power source electrically coupled to the power terminal block 28(2) and provide the portion of the input power to the surge protectors 24(2). The power terminal block 28(2) will provide surge protected output power from the input power based on interruption in the at least a portion of the input power by the surge protectors 24(2) during power surges, to be distributed externally from the surge protector housing 10(2) to other power-consuming equipment.

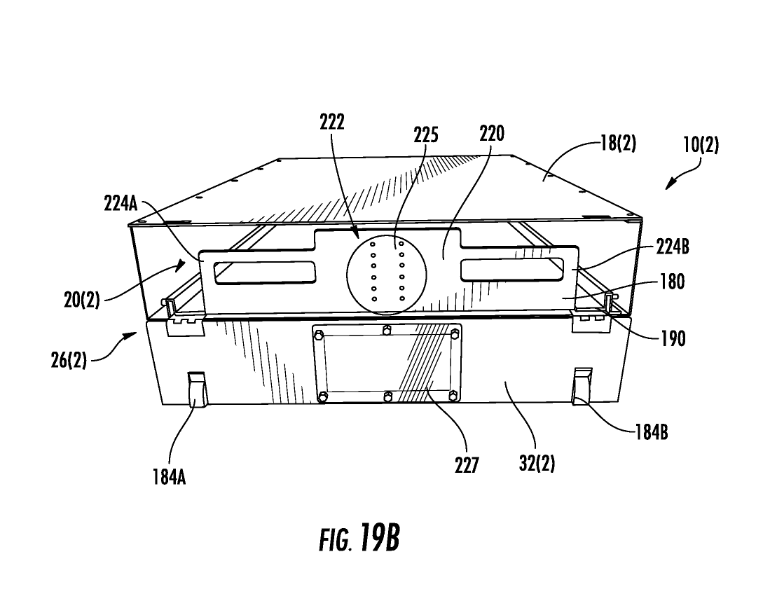

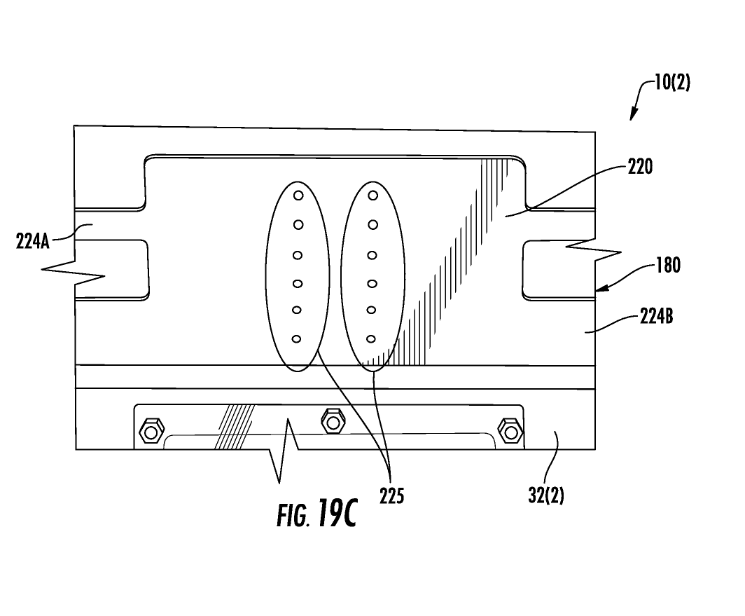

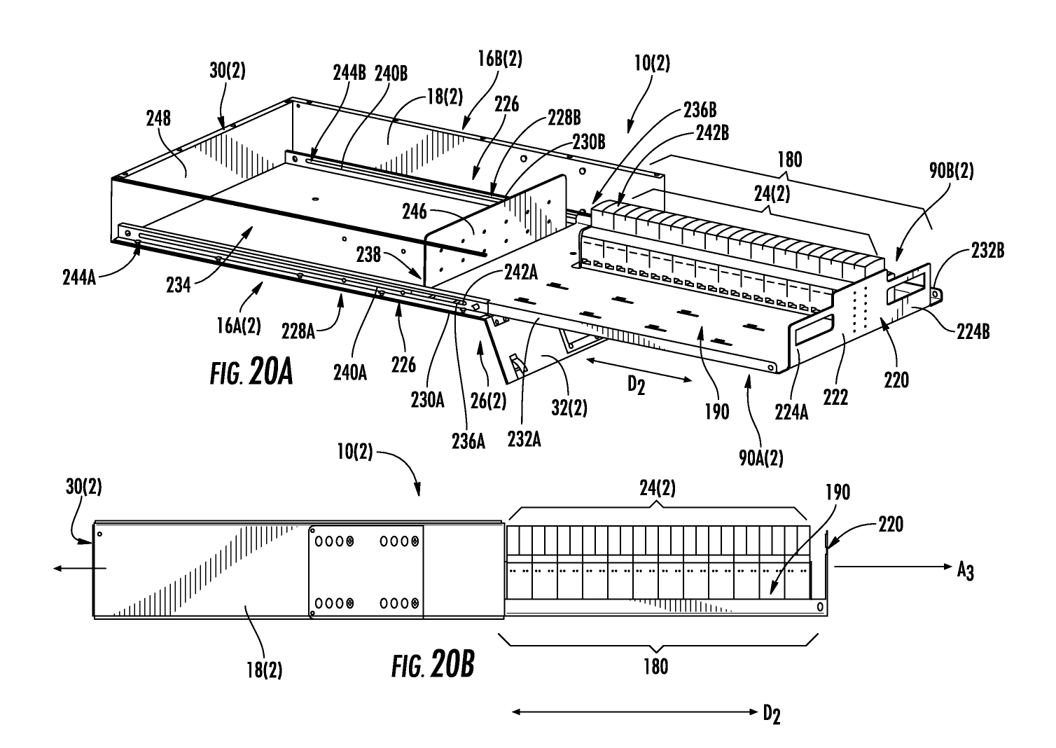

With reference back to FIG. 18, if it is desired to access the surge protectors 24(2) mounted on the surge protector tray 180 after the front door 32(2) is opened, a technician can extend the surge protector tray 180 out from the front end 26(2) of the chassis 18(2) (block 202). The surge protector tray 180 extended from the front end 26(2) of the chassis 18(2) of the surge protector housing 10(2) is shown in FIGS. 20A and 20B. FIG. 20A is a left side, perspective view of the surge protector housing 10(2) removed from the equipment rack 12, with the front door 32(2) lowered, and the surge protector tray 180 extended from the chassis 18(2), to provide access to the surge protectors 24(2) installed on the base 190 of the surge protector tray 180. FIG. 20B is a side view of the surge protector tray 180 of the surge protector housing 10(2) extended from the chassis 18(2), to provide access to the surge protectors 24(2) installed in the base 190 of the surge protector tray 180.

FIG. 20A also illustrates a guide system 226 provided in the surge protector housing 10(2) to allow the surge protector tray 180 to translate about the chassis 18(2) to be extended out from the front end 26(2) of the chassis 18(2). The guide system 226 allows the surge protector tray 180 to translate about the chassis 18(2), along a longitudinal direction D₂ along longitudinal axis A₃ between the front end 26(2) and the rear end 30(2) of the chassis 18(2), to allow the surge protector tray 180 to be extended out from the front end 26(2) of the chassis 18(2). In this regard, the guide system 226 in this embodiment includes guide members 228A, 228B provided as part of the chassis 18(2). The guide members 228A, 228B are disposed on the left side 16A(2) and the right side 16B(2) of the chassis 18(2), respectively, as illustrated in FIG. 20A. The guide members 228A, 228B each include guides 230A, 230B configured to allow complementary rail members 232A, 232B provided on the left side 90A(2) and right side 90B(2) of the surge protector tray 180, respectively, to be received in the guides 230A, 230B and translate therein. The rail members 232A, 232B of the surge protector tray 180 are provided as bent-up portions of the left and right sides 90A(2), 90B(2) of the surge protector tray 180 in this embodiment. The guides 230A, 230B of the chassis 18(2) are provided as separate members installed on left and right sides 16A(2), 16B(2) of a base 234 of the chassis 18(2) in this embodiment.

With continuing reference to FIG. 20A, to limit the translation of the surge protector tray 180 out from the chassis 18(2) and prevent the surge protector tray 180 from being removed from the chassis 18(2), the stops 236A, 236B are provided on the left and right sides 90A(2), 90B(2) of a rear end 238 of the surge protector tray 180. The stops 236A, 236B are disposed in and translate within slots 240A, 240B provided in the guides 230A, 230B. When the stops 236A, 236B encounter front end portions 242A, 242B of the slots 240A, 240B, the stops 236A, 236B are prevented from further translating forward thus preventing the surge protector tray 180 from further translating forward towards the front end 26(2). Similarly, when the stops 236A, 236B encounter rear end portions 244A, 244B of the slots 240A, 240B, the stops 236A, 236B are prevented from further translating backwards before a rear panel 246 of the surge protector tray 180 contacts the rear internal wall 248 of the rear end 30(2) of the chassis 18(2).

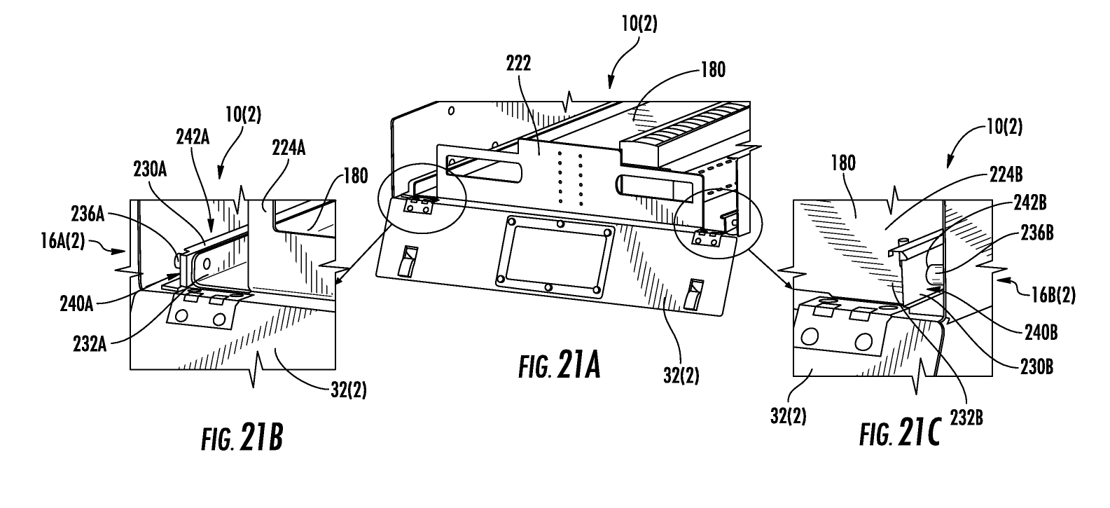

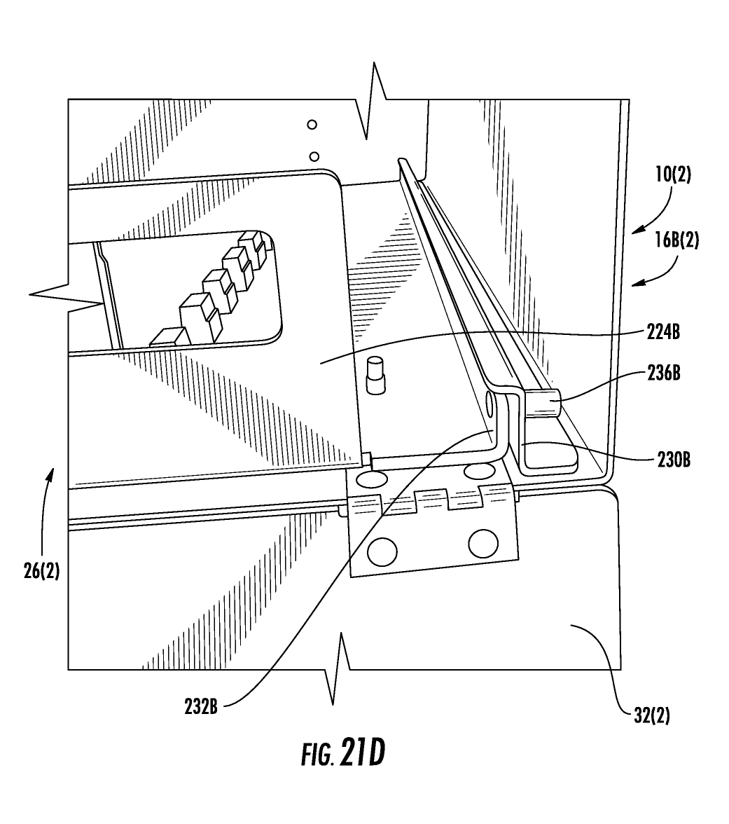

The stops 236A, 236B of the surge protector tray 180 engaged with the slots 240A, 240B of the guides 230A, 230B are also illustrated in more detail in FIGS. 21A-21C. FIG. 21A is a right side, front perspective view of the surge protector housing 180, with the front door 32(2) opened. FIG. 21B is a close-up view of the left side of FIG. 21A, to show the left side latching mechanism to limit translation of the surge protector tray 180. FIGS. 21C and 21D are close-up perspective and front views, respectively, of the right side of FIG. 21A, to show the right side latching mechanism to limit translation of the surge protector tray 180.

With reference back to FIG. 18, when it is desired to retract the surge protector tray 180 back into the chassis 18(2), a technician can simply push the front panel 220 of the surge protector tray 180 towards the rear end 30(2) of the chassis 18(2) (block 204). As previously discussed, the surge protector tray 180 can translate on its rail members 232A, 232B supported within the guides 230A, 230B of the chassis 18(2) until the stops 236A, 236B encounter rear end portions 244A, 244B of the slots 240A, 240B of the guides 230A, 230B, as illustrated in FIGS. 20A-21C. The door 32(2) can then be raised and latched to the chassis 18(2), if desired, as previously discussed (block 204 in FIG. 18), as illustrated in FIG. 16B.

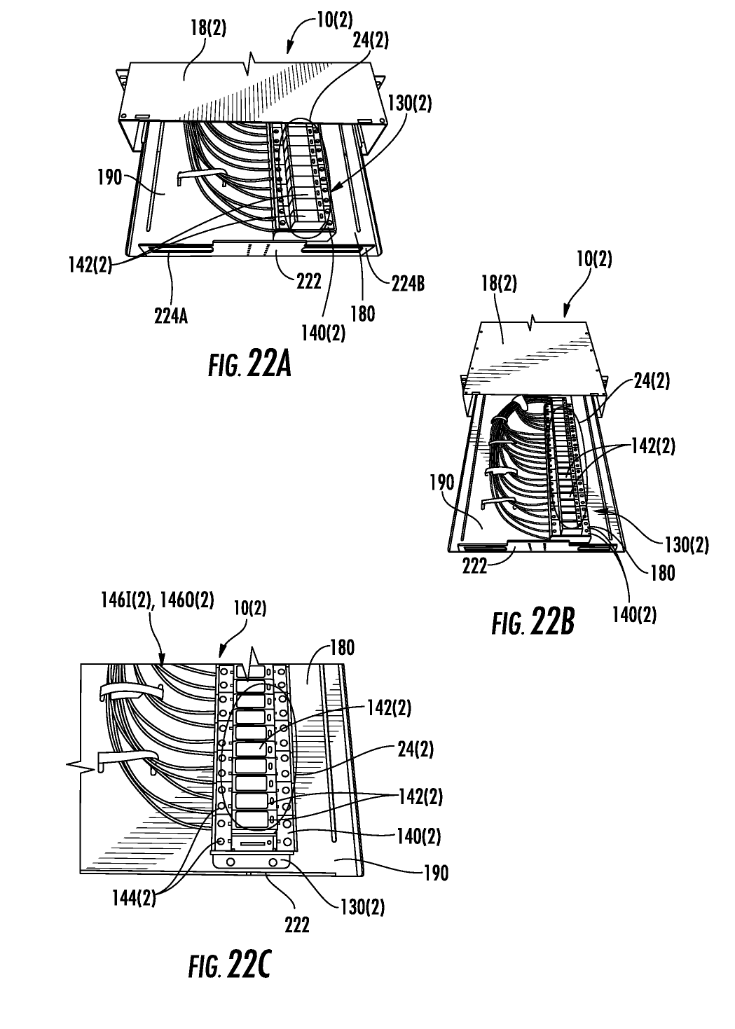

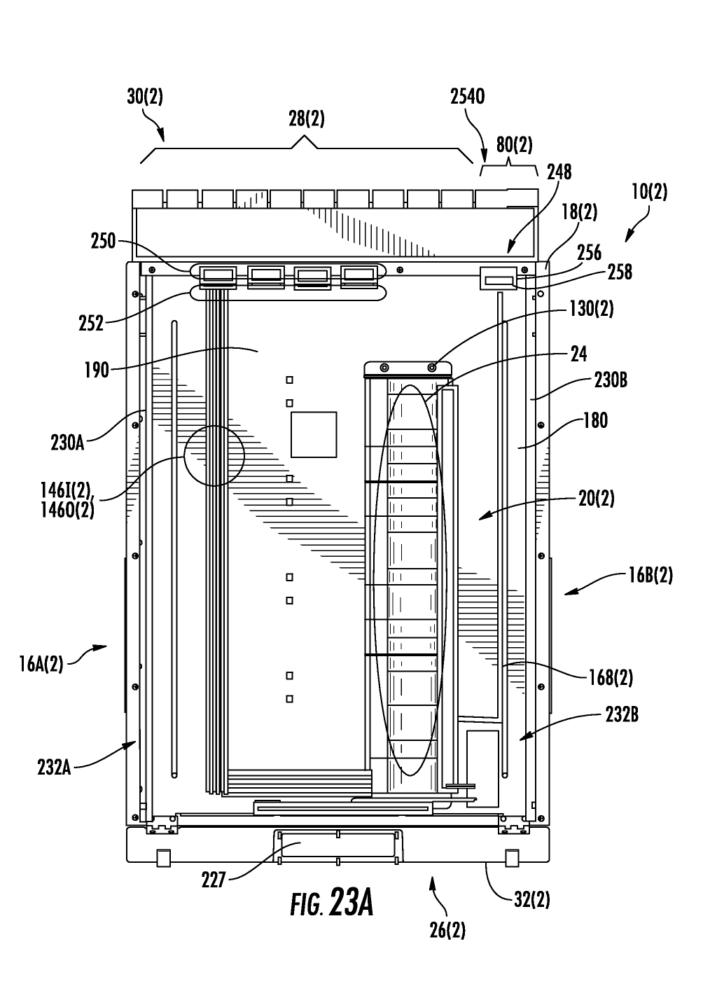

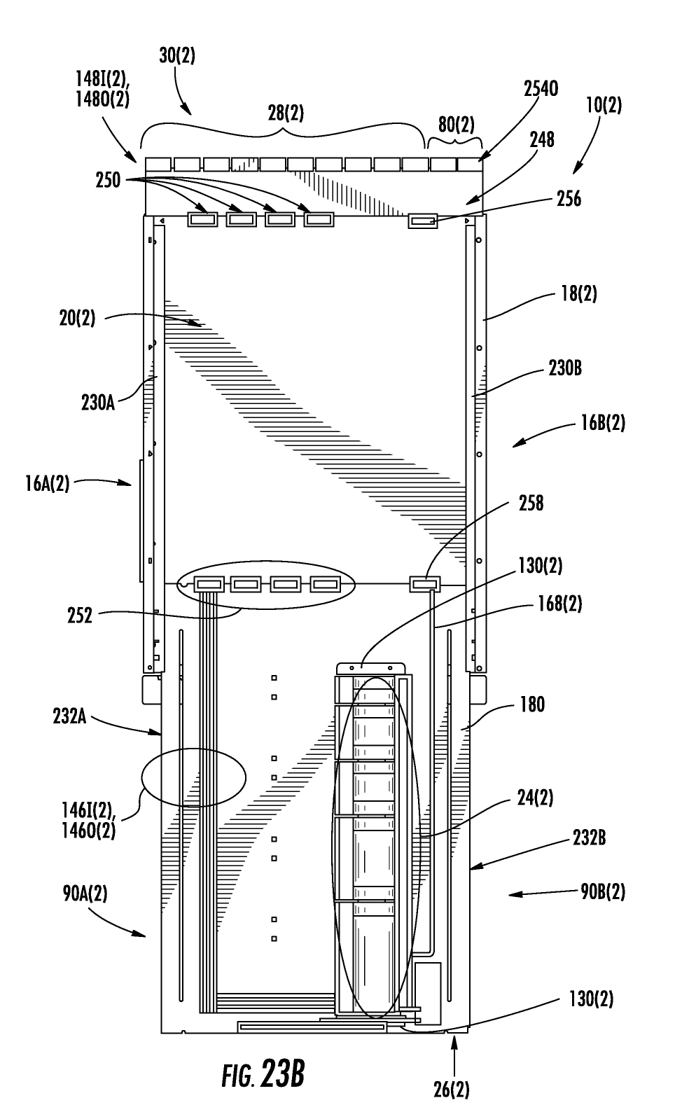

Now that the exemplary translation features of the surge protector tray 180 of the surge protector housing 10(2) have been discussed, the surge protection features of the surge protector housing 10(2) will now be described with regard to FIGS. 22A-23B.

FIG. 22A is a top, perspective view of the surge protector tray 180 of the surge protector housing 10(2) partially extended out from the chassis 18(2). FIG. 22B is a top, perspective view of the surge protector tray 180 of the surge protector housing 10(2) fully extended out from the chassis 18(2). FIG. 22C is a close-up view of FIG. 22B illustrating modular surge protector modules 142(2) of the surge protectors 24(2) mounted in surge protector base 140(2) that are mounted to the translatable surge protector tray 180, with one surge protector 24(2) removed from a surge protector base 140(2). The surge protector modules 142(2) and surge protector base 140(2) are the same as surge protector modules 142 and surge protector base 140 in FIGS. 10-11B-2 previously described in this example, and thus will not be re-described here. As shown in FIGS. 22A-22C, an exemplary surge protector mounting rail 130(2) is disposed in and mounted to the base 190 of the surge protector tray 180. The mounting rail 130(2) in this embodiment is the same mounting rail as mounting rail 130 provided in surge protector housing 10 described above with regard to FIGS. 1-15B. The surge protector base 140(2) mount to the mounting rail 130(2) in the same manner as the surge protector base 140 mount to the mounting rail 130 previously described above with regard to FIGS. 10-11B-2 in this example. The mounting rail 130(2) allows the surge protectors 24(2) to be installed in the surge protector tray 180 modularly and tool-lessly in this embodiment. The mounting rail 130(2) can be fastened to the base 190 of the surge protector housing 180 in the same manner as mounting rail 130 is secured to the front section 22 of surge protector housing 10, and thus will not be re-described.

With continuing reference to FIGS. 22A-22C, the mounting rail 130(2) contains two raised portions (not shown) that are configured to lock into complementary features in the housings of surge protectors 24(2) to lock the surge protectors 24(2) onto the mounting rail 130(2) when installed therein. In this manner, no tools are required to mount the surge protectors 24(2) in the surge protector tray 180. This may be advantageous if a technician desires to install or replace surge protectors 24(2) in the surge protector tray 180 without disconnecting power to the surge protector housing 10(2). Use of tools with metal parts or other electrical conductors provides a risk of a technician improperly following procedures establishing a conductive path between power components and the technician.

As will be discussed in more detail below, with reference to FIG. 22C, the surge protector base 140(2) includes terminals 144A(2), 144B(2) for receiving the portion of the input power over input electrical wiring 146I(2) and interrupting the input power provided as surge protected output power from the input power over output electrical wiring 146O(2) during power surges. These features will now be described with regard to FIGS. 23A-23B below.

FIGS. 23A and 23B are top views of the interior area 20(2) of the chassis 18(2) of the surge protector housing 10(2), illustrating exemplary electrical connections between the surge protectors 24(2) installed on the surge protector tray 180 and the power terminal block 28(2) and an alarm terminal block 80(2). The power terminal block 28(2) and the alarm terminal block 80(2) are disposed are the rear end 30(2) of the chassis 18(2). In this embodiment, the power terminal block 28(2) includes at least one input power terminal 148I(2) (shown in FIG. 23B) configured to be coupled to at least one input power line to receive input power. The power terminal block 28(2) also includes at least one output power terminal 148O(2) (shown in FIG. 23B) configured to be coupled to at least one output power line to receive and distribute output power from the surge protectors 24(2) to equipment outside of the surge protector housing 10(2). The input power terminals 148I(2) and output power terminals 148O(2) are coupled to power chassis connectors 250 that are disposed in the rear internal wall 248 of the rear end 30(2) of the chassis 18(2). The power chassis connectors 250 could be female or male connectors as non-limiting examples.

With reference to FIG. 23A, the power chassis connectors 250 are configured to be connected to complementary tray power connector 252 disposed in a rear end 238 (shown in FIG. 20A) of the surge protector tray 180 when the surge protector tray 180 is retracted in the chassis 18(2), as illustrated in FIG. 23A. The tray power connectors 252 could be female or male connectors as non-limiting examples, but complementary to the power chassis connectors 250 in this example. Input and output electrical wiring 146I(2), 146O(2) is routed in the surge protector tray 180 to connect the tray power connectors 252 to the surge protectors 24(2). Thus, in this manner, when the surge protector tray 180 is retracted in the chassis 18(2), the surge protectors 24(2) are operable to receive a portion of the input power coming into the surge protector housing 10(2) through the input power terminals 148I(2), and interrupt the input power provided as surge protected power from the input power to the output power terminals 148O(2) (shown in FIG. 23B) during power surges. This configuration is illustrated in FIG. 23A. With this arrangement, when the surge protector tray 180 is translated out from the chassis 18(2), the tray power connectors 252 are disconnected and decoupled from the power chassis connectors 250. In this manner, any portion of the input power provided on the input power terminals 148I(2) is decoupled and not provided to the surge protectors 24(2). Thus, the external input power is provided to the power terminal block 28(2). This feature and arrangement may be desired if it is desired for power to be removed from the surge protectors 24(2) if a technician translates the surge protector tray 180 to access the surge protectors 24(2). The input and output electrical wiring 146I(2), 146O(2) can be routed in any manner desired without need to consider translation connectivity issues, because the input and output electrical wiring 146I(2), 146O(2) is decoupled from the power chassis connectors 250 as a result of surge protector tray 180 translation. The input and output electrical wiring 146I(2), 146O(2) always translates with the surge protector tray 180 in this design.

A similar arrangement is provided with regard to the alarm features in the surge protector housing 10(2). In this regard, the alarm terminal block 80(2) includes at least one output alarm terminal 254O configured to be coupled to at least one output alarm line to receive and distribute output alarms from the surge protectors 24(2) to equipment outside of the surge protector housing 10(2). The output alarm terminals 254O are coupled to a chassis alarm connector 256 disposed in the rear internal wall 248 of the rear end 30(2) of the chassis 18(2). The chassis alarm connector 256 is configured to be connected to complementary tray alarm connector 258 disposed in a rear end 238 of the surge protector tray 180 when the surge protector tray 180 is retracted in the chassis 18(2), as illustrated in FIG. 23A. Alarm wiring 168(2) is routed in the surge protector tray 180 to connect the tray alarm connector 258 to the surge protectors 24(2). Thus, in this manner, when the surge protector tray 180 is retracted in the chassis 18(2), the surge protectors 24(2) are operable to provide any alarms to output alarm terminal 254O. This configuration is illustrated in FIG. 23A.

With this arrangement of the surge protector housing 10(2) in FIG. 23A, when the surge protector tray 180 is translated out from the chassis 18(2), the tray alarm connector 258 is disconnected and decoupled from the chassis alarm connector 256. This feature and arrangement may be desired if it is desired for alarms to not be reported by the surge protectors 24(2) if a technician translates the surge protector tray 180 to access the surge protectors 24(2). This arrangement may prevent false alarms from being generated, such as if alarms are generated if power is disconnected from the surge protectors 24(2), such as when the surge protector tray 180 is translated out of the chassis 18(2). The alarm wiring 168(2) can be routed in any manner desired without need to consider translation connectivity issues, because the alarm wiring 168(2) will be disconnected when the surge protector tray 180 is translated anyways. The alarm wiring 168(2) always translates with the surge protector tray 180 in this design.

Note that in the surge protector housing 10(2) in FIGS. 16A-23B, the chassis 18(2) and the surge protector tray 180 could be provided without the power chassis connectors 250 and complementary tray power connectors 252, respectively. The input electrical wiring 146I(2) and output electrical wiring 146O(2) could be directly coupled between the power terminal block 28(2) and the surge protectors 24 (namely the surge protector bases 140 in this example). This is similar to the electrical wiring design provided in the surge protector housing 10 in FIGS. 1A-15B. Similarly, the chassis alarm connector 256 disposed in the rear internal wall 248 of the rear end 30(2) of the chassis 18(2), and the complementary tray alarm connector 258 disposed in a rear end 238 of the surge protector tray 180 may not be included in the surge protector housing 10(2). This is similar to the alarm wiring design provided in the surge protector housing 10 in FIGS. 1A-15B. The input electrical wiring 146I(2) and output electrical wiring 146O(2), and alarm wiring 168(2) would be routed in the interior area 20(2) of the chassis 18(2). Enough slack of the input electrical wiring 146I(2) and output electrical wiring 146O(2), and alarm wiring 168(2) would be routed in the interior area 20(2) of the chassis 18(2) could be provided in the interior area 20(2) of the chassis 18(2) to allow the surge protector tray 180 to be translated out of the chassis 18(2) without damaging and/or disconnecting the input electrical wiring 146I(2) and output electrical wiring 146O(2), and alarm wiring 168(2) would be routed in the interior area 20(2) of the chassis 18(2).

It may be desired to provide a surge protector housing that does not include translation features, but allows access to surge protectors disposed therein. In this regard, FIG. 24 is a left side, perspective view of an alternative exemplary surge protector housing 10(3) mounted in an equipment rack 12. As will be discussed in more detail below, the surge protector housing 10(3) includes a chassis 18(3) for supporting and providing access to surge protectors 24(3) mounted therein providing surge protection for electrical devices, including electrical communications devices. In this embodiment, surge protectors 24(3) therein are disposed orthogonally from their orientation in surge protector housings 10(1), 10(2) described above. This design provides for the surge protectors 24(3) to extend in a vertical, height direction that is greater than a 2-U size surge protector housing can accommodate in this example. Thus, in this example, the surge protector housing 10(3) is 3-U in size as an example.

With reference to FIG. 24, the surge protector housing 10(3) is mounted in the equipment rack 12 in this example as a convenient method to support an installation of the surge protector housing 10(3). The surge protector housing 10(3) contains flange brackets 14A(3), 14B(3) on the left side 16A(3) and right side 16B(3) of the surge protector housing 10(3) for mounting the surge protector housing 10(3) to the equipment rack 12. For example, the equipment rack 12 may support equipment, including the surge protector housing 10(3), that is nineteen inches (19″) or twenty-three inches (23″) in width, as a non-liming example. The equipment rack 12 may be installed at a facility that includes base stations for supporting cellular communications. Providing surge protection for communications equipment may be particularly important, so that the risk of communications equipment being damaged from power surges and spikes is reduced to avoid or reduce communications service interruptions.

With continuing reference to FIG. 24, the surge protector housing 10(3) comprises the chassis 18(3) that provides an interior area 20(3) for supporting surge protectors 24(3) and electrical wiring connecting the surge protectors 24(3). A plurality of the surge protectors 24(3) are mounted at the front end 26(3) of the chassis 18(3) to be accessible through the front end 26(3) of the surge protector housing 10(3). As will be discussed in more detail below, the surge protectors 24(3) are electrically coupled to a power terminal block 28(3) disposed in the chassis 18(3) to route a portion of the input power to the surge protectors 24(3). In this embodiment, the power terminal block 28(3) is disposed in a rear end 30(3) of the chassis 18(3). The surge protectors 24(3) receive the portion of the input power and interrupt the input power provided as surge protected output power from the input power to the power terminal block 28(3), during power surges, to be distributed to other power-consuming electrical equipment. In this embodiment, the surge protectors 24(3) are supported by the surge protector housing 10(3) as a single housing. As illustrated in FIG. 24, a front door 32(3) of the surge protector housing 10(3) is provided and shown opened, but can be closed to close off access to the interior area 20(3) of the chassis 18(3) to close off access to the front end 26(3) and the surge protectors 24(3) mounted therein in the surge protector housing 10(3).

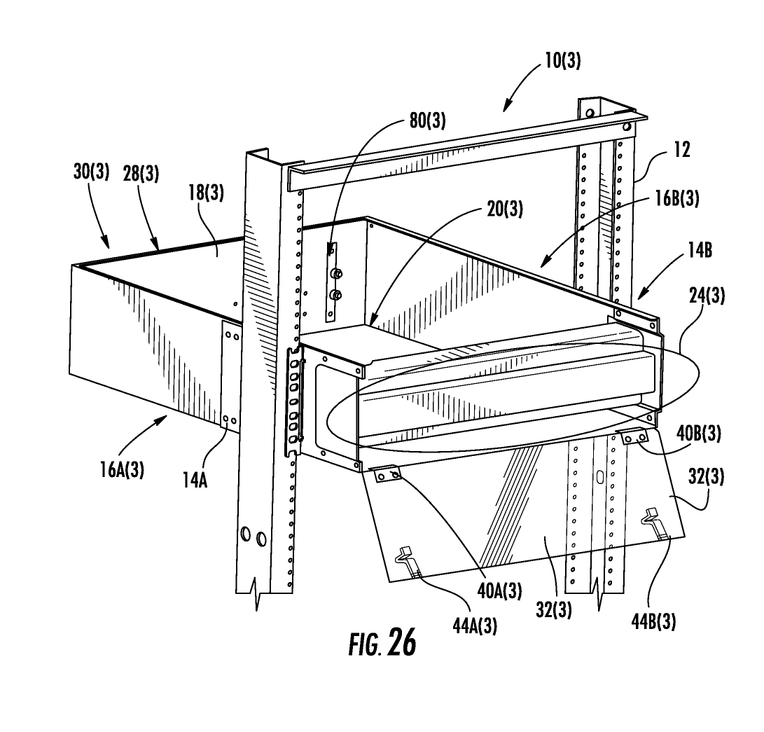

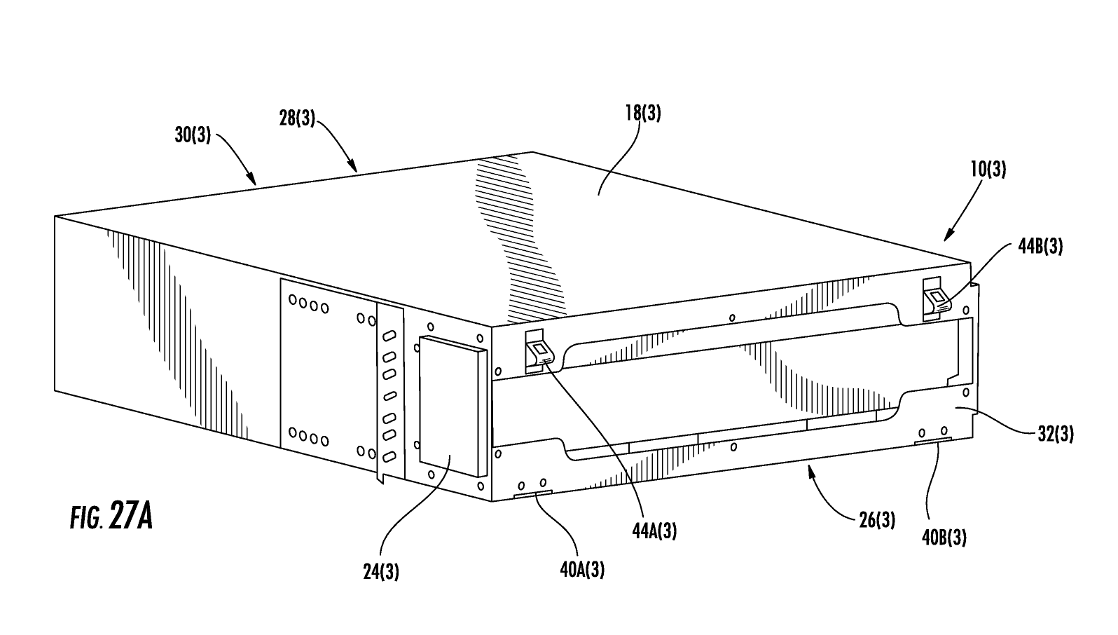

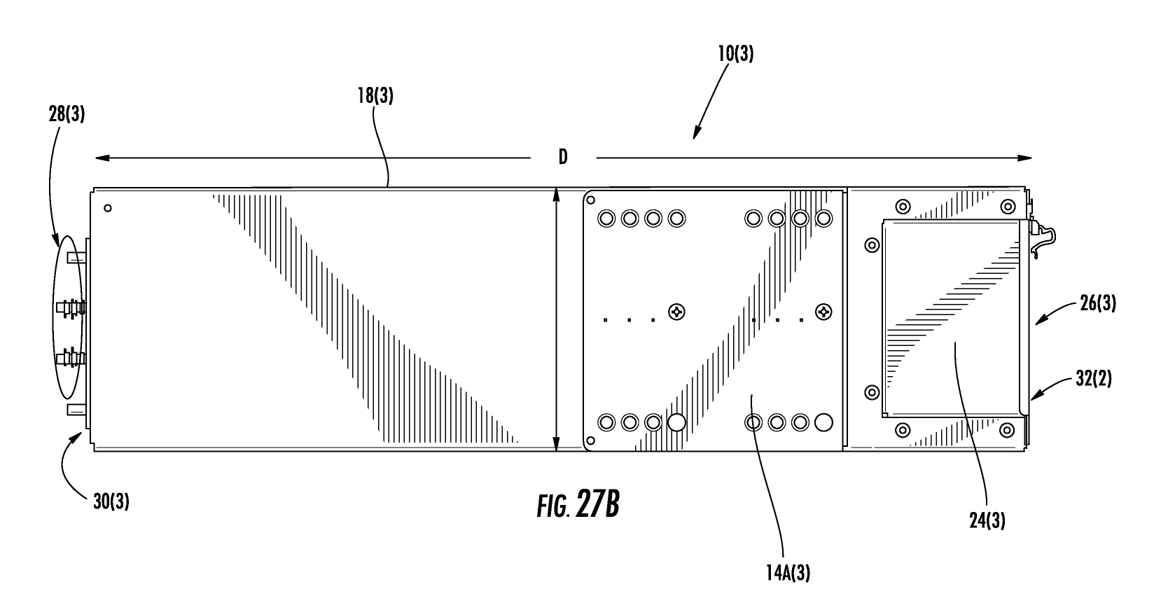

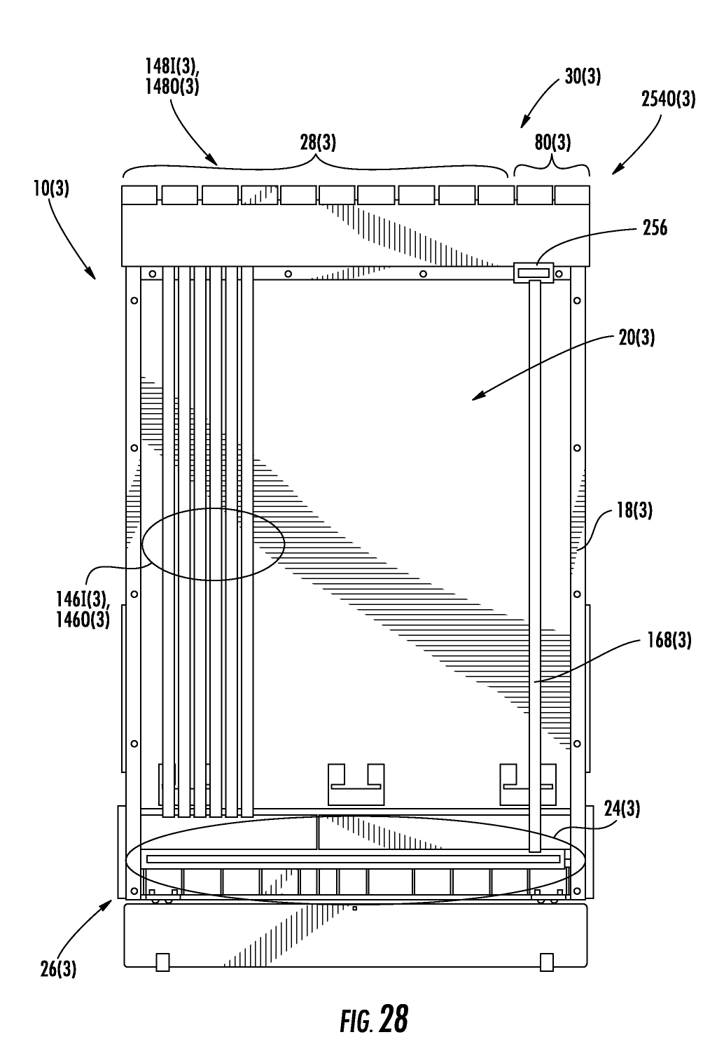

FIG. 25 is a front view of the surge protector housing 10(3) in FIG. 24, illustrating front views of the surge protectors 24(3) installed at the front end 26(3) of the chassis 18(3). The front door 32(3) of the surge protector housing 10(3) is lowered to provide access to the front end 26(3) of the chassis 18(3). The front door 32(3) is attached to the chassis 18(3) with hinges 40A(3), 40B(3) disposed at the bottom section 42(3) of the left side 16A(3) and right side 16B(3) of the front end 26(3) of the chassis 18(3) in this embodiment. To secure the front door 32(3) in a closed position on the surge protector housing 10(3) as illustrated in FIG. 27A discussed below, latches 44A(3), 44B(3) disposed in the rear panel 46(3) of the front door 32(3) can be engaged and latched into a top section 48(3) of the chassis 18(3).

With continuing reference to FIG. 25, the front end 26(3) of the chassis 18(3) is configured to support a plurality of the surge protectors 24(3). As will be discussed in more detail below, a base 260 of the chassis 18(3) includes a mounting structure at the front end 26(3) of the chassis 18(3) that allows a plurality of the surge protectors 24(3) to be installed side-by-side in the chassis 18(3) at the front end 26(3). By the surge protectors 24(3) being mountable side-by-side in the front end 26(3) of the chassis 18(3), each of the surge protectors 24(3) are accessible from the front end 26(3) of the surge protector housing 10(3) without the need for translating components. Each of the surge protectors 24(3) can independently provide surge protected output power to different equipment. In this manner, each surge protector 24(3) is independently installable and removable from the chassis 18(3). A technician can install or remove certain surge protectors 24(3) in the chassis 18(3) of the surge protector housing 10(3) without disturbing other installed surge protectors 24(3) in the surge protector housing 10(3).

The surge protector housing 10(3) in FIG. 26 is illustrated with the top of the chassis 18(3) removed and the interior area 20(3) of the chassis 18(3) exposed to provide more detail. As will be discussed in more detail below, the interior area 20(3) of the chassis 18(3) is where electrical wiring (not shown) will be routed for electrical connection to the surge protectors 24(3) to provide the portion of the input power to the surge protectors 24(3). As discussed above, the surge protectors 24(3) receive the input power and interrupts the input power provided as surge protected output power from the input power during power surges. The surge protectors 24(3) receive the portion of the input power over electrical wiring coupled to the power terminal block 28(3) disposed in the rear end 30(3) of the chassis 18(3). The power terminal block 28(3) is configured to receive input power from an external power source electrically coupled to the power terminal block 28(3) and route the input power to the surge protectors 24(3). The power terminal block 28(3) will also receive surge protected output power from the surge protectors 24(3) to be distributed externally from the surge protector housing 10(3) to other power-consuming equipment. In one embodiment, the surge protectors 24(3) are the surge protectors 24 described above and illustrated in FIGS. 10-11B-2.

As will also be discussed in more detail below, with continuing reference to FIG. 26, an alarm terminal block 80(3) is also disposed in the rear end 30(3) of the chassis 18(3) of the surge protector housing 10(3). The alarm terminal block 80(3) provides terminals for coupling of alarm wiring (not shown) routed in the interior area 20(3) from the surge protectors 24(3). The surge protectors 24(3) may be configured to generate and transmit alarms over alarm wiring coupled to the alarm terminal block 80(3). The alarms generated by the surge protectors 24(3) may indicate if a surge protector 24(3) has a fault or has failed. The alarms may be used by technicians or other systems to schedule repairs and replacements of the surge protectors 26(3) in the surge protector housing 10(3). In this manner, the alarms can be transmitted over external alarm wiring coupled to the alarm terminal block 80(3) external to the surge protector housing 10(3).

FIG. 27A is a left side, perspective view of the surge protector housing 10(3) mounted in the equipment rack 12 (not shown) with the front door 32(3) closed to close off access to the surge protectors 24(3) disposed in the front end 26(3) of the chassis 18(3). FIG. 27B is a side view of the surge protector housing 10(3) in FIG. 27A with a front door 32(2) closed about a chassis 18(3) of the surge protector housing 10(3). The surge protector housing 10(3) may be based on a “U”-based size with “U” equal to a standard 1.75 inches in height, as a non-limiting example. As non-limiting examples, the surge protector housing 10(3) may be a 1-U, 2-U, or 3-U size, although the surge protector housing 10(3) shown in FIGS. 27A and 27B is a 3-U size.

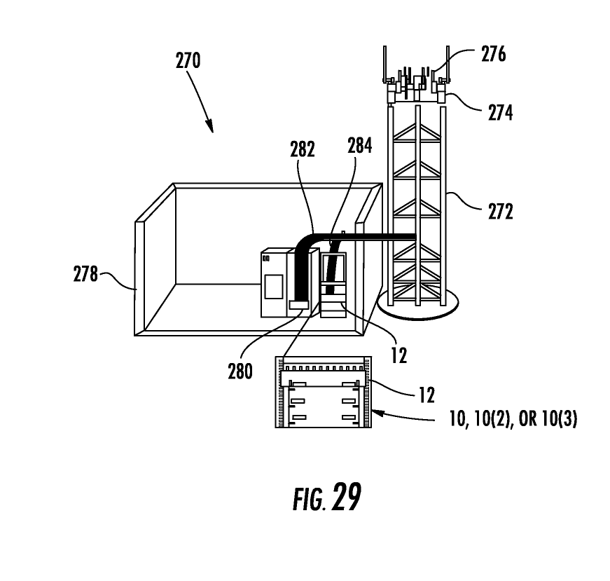

FIG. 28 is a top view of the interior area 20(3) of the chassis 18(3) of the surge protector housing 10(3), illustrating exemplary electrical connections between the surge protectors 24(3) installed in the front end 26(3) of the chassis 18(3) and the power terminal block 28(3) and an alarm terminal block 80(3). The power terminal block 28(3) and the alarm terminal block 80(3) are disposed in the rear end 30(3) of the chassis 18(3). In this embodiment, the power terminal block 28(3) includes at least one input power terminal 148I(3) configured to be coupled to at least one input power line to receive input power. The power terminal block 28(3) also includes at least one output power terminal 148O(3) configured to be coupled to at least one output power line to receive and distribute output power from the surge protectors 24(3) to equipment outside of the surge protector housing 10(3).

With continuing reference to FIG. 28, input and output electrical wiring 146I(3), 146O(3) is routed in the chassis 18(3) that connects the input and output power terminals 148I(3), 148O(3) to the surge protectors 24(3). The surge protectors 24(3) are operable to receive at least a portion of the input power coming into the surge protector housing 10(3) through the input power terminals 148I(3), and interrupt the received input power provided as surge protected output power from the input power to the output power terminals 148O(3) during power surges. The input and output electrical wiring 146I(3), 146O(3) can be routed in the interior area 20(3) of the chassis 18(3) in any manner.

A similar arrangement is provided with regard to the alarm features in the surge protector housing 10(3). In this regard, the alarm terminal block 80(3) includes at least one output alarm terminal 254O(3) configured to be coupled to at least one output alarm line to receive and distribute output alarms from the surge protectors 24(3) to equipment outside of the surge protector housing 10(3). The output alarm terminals 254O(3) are coupled to the surge protectors 24(3). Alarm wiring 168(3) is routed in the interior area 20(3) of the chassis 18(3) to connect the output alarm terminals 254O(3) to the surge protectors 24(3).

The surge protector housings disclosed herein, including surge protector housings 10(1), 10(2), and 10(3) described above, can be employed to provide surge protected power in communications equipment, including base station equipment. In this regard, FIG. 29 is a schematic diagram of a cellular tower site 270. The cellular tower site 270 includes a cellular tower 272. In some cellular base station installations, such as in FIG. 29, remote radio heads (RRHs) 274 are installed on the cellular tower 272 along with radio antennas 276. A base station enclosure 278 is provided at the cellular tower site 270 that includes a base station transmitter 280 and equipment rack 12 having a surge protector housing 10(1), 10(2), or 10(3) installed therein, for providing surge protection to power distributed to the RRHs 274.

Fiber to the Antenna (“FTTA”) solutions may be employed to distribute optical communications signals to the RRHs 274 on cellular tower 272. The RRHs 274 convert the optical communications signals to electrical communications signals for transmission as wireless communications signals over the radio antennas 276, and vice versa for wireless communications signals received over the radio antennas 276. In this regard, fiber optic cables 282 extend from the base station transmitter 280 to the cell tower 272 and up to the RRHs 274 to carry communications signals to and from the base station transmitter 280 to the RRHs 274 to be communicated over and received from the radio antennas 276.

Surge protection can also be built into the RRHs 274. However, some wireless service providers (WSPs) desire additional surge protection beyond what is built into the RRHs 274 by the RRH manufacturer. Also, providing surge protection in the RRHs 274 or mounting the surge protectors on the RRHs 274 increases the size of the RRHs 274. Increasing the size of the RRHs 274 can increase the WSPs' expense. Often, space on the cellular tower 272 is leased by WSPs based on space consumed by installed equipment on the cellular tower 272. The larger the RRH 274 and support equipment installed on the cellular tower 272, the more space on the cellular tower 272 required and the greater the lease expense. If the WSP provides a typical installation of multiple radios, multiple corresponding RRHs 274 would be installed on a cellular tower 272. Thus, an increase in RRH 274 size from inclusion of surge protectors can have a multiplying effect on the space consumed by the WSP on the cellular tower 272. In this regard, with continuing reference to FIG. 29, the cellular tower site 270 includes power cables 284 also extending from surge protector housing 10(1)-10(3) to the cell tower 272 and up to the RRHs 274 to provide surge protected power to the RRHs 274.

As used herein, it is intended that terms “electrical power cable” and/or “electrical conductor” include all types of cables and/or conductors used to transmit electrical power manufactured of any conductive material, including without limitation, copper and aluminum and in any form, including without limitation, multiple or individual conductors and whether jacketed, armored, and/or the like.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163, the disclosures of which are incorporated herein by reference in their entireties.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. A surge protector housing, comprising:
a chassis comprising an interior area defined by a front end having a front opening and a rear end;
a power terminal block disposed in the chassis;
a front section supported at the front end of the chassis and accessible through the front opening of the chassis, the front section including at least one surge protector mounted to the front section, the at least one surge protector electrically coupled to the power terminal block with electrical power wiring routed in the interior area of the chassis; and
at least one tilt mechanism connecting the chassis to the front section, the at least one tilt mechanism configured to be engaged to tilt the front section about the chassis to tilt the at least one surge protector about the chassis to provide tilt access to the at least one surge protector.

2. The surge protector housing of claim 1, wherein the at least one tilt mechanism is configured to releasably engage the front section with the chassis.

3. The surge protector housing of claim 1, wherein the at least one tilt mechanism is comprised of:
at least one tilt plate disposed in the chassis, the at least one tilt plate comprising at least one tilt position stop; and
at least one tilt configured to releasably engage with the at least one tilt position stop in the at least one tilt plate to tilt the front section about the chassis in at least one tilt position corresponding to the at least one tilt position stop.

4. The surge protector housing of claim 1, wherein the at least one tilt mechanism is comprised of at least one spring plunger configured to engage with an orifice disposed in the front section.

5. The surge protector housing of claim 1, wherein the at least one tilt mechanism is comprised of:
a first tilt mechanism disposed on a first side of the chassis and configured to engage a first side of the front section with a first side of the chassis; and
a second tilt mechanism disposed on a second side of the chassis and configured to engage a second side of the front section with a second side of the chassis.

6. The surge protector housing of claim 1, further comprising at least one guide member disposed in the chassis and receiving at least one complementary guide member connected to the front section, the at least one complementary guide member translatable about the at least one guide member to allow the front section to be translated about a longitudinal direction between the front end of the chassis and the rear end of the chassis.

7. The surge protector housing of claim 6, wherein the front section is retractable into the interior area of the chassis when the at least one complementary guide member is retracted on the at least one guide member.

8. The surge protector housing of claim 7, wherein the front section cannot tilt about the chassis when the front section is retracted in the interior area of the chassis.

9. The surge protector housing of claim 6, wherein the front section is extendible from the interior area of the chassis through the front opening of the chassis when the at least one complementary guide member is extended on the at least one guide member.

10. The surge protector housing of claim 6, wherein the front section is tiltable about the chassis when the front section is extended from the interior area through the front opening of the chassis.

11. The surge protector housing of claim 10, wherein the front section comprises a rear end extended from the interior area of the chassis when the at least one complementary guide member is fully extended on the at least one guide member.

12. The surge protector housing of claim 1, further comprising a mounting rail disposed in the chassis, the at least one surge protector mounted to the mounting rail.

13. The surge protector housing of claim 1, wherein the at least one surge protector is configured to be tool-lessly mounted to at least one surge protector chassis mounted to the front section.

14. The surge protector housing of claim 1, wherein the at least one surge protector is comprised of a plurality of surge protectors, the plurality of surge protectors are modularly mounted to the front section.

15. The surge protector housing of claim 1, wherein the electrical power wiring is comprised of at least one input electrical wire and at least one output electrical wire.

16. The surge protector housing of claim 15, wherein the power terminal block is comprised of:
at least one input power terminal configured to receive input power from at least one input power line connected to the at least one input power terminal, and provide at least a portion of the input power over the at least one input electrical wire connected to the at least one surge protector; and
at least one output power terminal configured to receive output power from the at least one output electrical wire connected to the at least one surge protector, and provide surge protected output power to at least one output power line connected to the at least one output power terminal, based on the at least one surge protector interrupting the input power during power surges.

17. The surge protector housing of claim 1, wherein the power terminal block is disposed through a rear wall of the chassis.

18. The surge protector housing of claim 1, wherein an alarm terminal of the at least one surge protector is electrically coupled to an alarm terminal block with alarm electrical wiring routed in the interior area of the chassis.

19. The surge protector housing of claim 1 mounted in an equipment rack.

20. The surge protector housing of claim 1, wherein the at least one surge protector surge protects at least one remote radio head.

21. The surge protector housing of claim 1, wherein the at least one surge protector is comprised of a plurality of surge protectors each surge protecting a remote radio head among a plurality of remote radio heads.

22. A method of providing access to surge protectors in a surge protector housing mounted in an equipment rack, comprising:
releasing at least one tilt mechanism releasably engaging a chassis of a surge protector housing to a front section supported at a front end of the chassis at a non-tilt position stop, the front section including at least one surge protector mounted to the front section, the at least one surge protector electrically coupled to a power terminal block disposed in the chassis with power electrical wiring routed in an interior area of the chassis; and
tilting down the front section of the surge protector housing about the chassis to provide tilt access to the at least one surge protector mounted in the front section.

23. The method of claim 22, wherein releasing the at least one tilt mechanism further comprises releasing the at least one tilt mechanism from a non-tilt position stop disposed in at least one tilt plate coupled to the chassis.

24. The method of claim 22, further comprising engaging the at least one tilt mechanism while the front section is tilted down, in a tilt position stop.

25. The method of claim 24, wherein engaging the at least one tilt mechanism in the tilt position stop further comprises engaging the at least one tilt mechanism in a tilt position stop disposed in at least one tilt plate coupled to the chassis while the front section is tilted down.

26. The method of claim 22, further comprising extending the front section through a front opening in the front end of the chassis to provide access to the at least one surge protector mounted in the front section.

27. The method of claim 26, comprising extending the front section from the front end of the chassis before releasing the at least one tilt mechanism and tilting down the front section of the surge protector housing.

28. The method of claim 27, further comprising:
disengaging the at least one tilt mechanism from a tilt position stop disposed in the chassis;
un-tilting the front section about the chassis to provide for the front section to be aligned with the front end of the chassis;
engaging the at least one tilt mechanism into the non-tilt position stop to secure the front section in an un-tilted position about the front end of the chassis; and
retracting the front section through the front opening into the front end of the chassis.

29. The method of claim 22, comprising mounting the at least one surge protector in a surge protector base mounted on a mounting rail disposed in the front section.

30. The method of claim 29, comprising tool-lessly unmounting the at least one surge protector from at least one surge protector base mounted to the mounting rail disposed in the front section.

31. A base station, comprising:
at least one base station equipment;
an equipment rack;
at least one surge protector housing mounted in the equipment rack, the at least one surge protector housing comprising a chassis, a tiltable front section supported at a front end of the chassis, and a front section including at least one surge protector mounted to the front section, the at least one surge protector electrically coupled to a power terminal block, the tiltable front section configured to be tilted to provide access to the at least one surge protector;
an input power line coupled to the power terminal block to couple at least a portion of input power to the at least one surge protector;
the at least one surge protector comprising an output electrical wire coupled to the power terminal block and configured to interrupt the input power provided as surge protected output power on an output power line coupled to the power terminal block during power surges on the input power, the output power line coupled to the at least one base station equipment to provide the surge protected output power to the at least one base station equipment.

32. The base station of claim 31, wherein the at least one base station equipment is comprised of at least one remote radio head (RRH).

33. The base station of claim 31, wherein the at least one base station equipment is mounted in the equipment rack.
